(19) United States
(12) Patent Application Publication
(10) Pub. No.: US 2006/0182162 A1
(43) Pub. Date: Aug. 17, 2006

(54) Solid laser exciting module and laser oscillator

(76) Inventors: Takayuki Yanagisawa, Tokyo (JP); Syuhei Yamamoto, Tokyo (JP); Yoshihito Hirano, Tokyo (JP)

Correspondence Address: BIRCH STEWART KOLASCH & BIRCH, PO BOX 747, FALLS CHURCH, VA, 22040-0747, US

(21) Appl. No.: 10/565,843

(22) PCT Filed: Jul. 29, 2003
(86) PCT No.: PCT/JP03/09603

§ 371 Date: Jan. 26, 2006

(51) Int. Cl. H01S 3/091; H01S 3/093; H01S 3/094

(52) U.S. Cl. 372/70; 372/72; 372/75

(57) ABSTRACT

A pumping module includes a plate-shaped solid state laser medium, a reflecting member disposed on a surface of the laser medium which is opposite to a light incidence surface of the laser medium, for reflecting laser light incident upon the laser medium via the light incidence surface and propagating through the laser medium, and a heat sink for removing heat transferred thereto, via the reflecting member, from the laser medium, the light incidence surface having a size of a in a direction perpendicular to a plane defined by both the optical axis of the laser light and the normal to the light incidence surface, and a size of b in a longitudinal direction perpendicular to the former direction and the normal, the sizes having a relationship given by b=a/cos θ, where θ is an incidence angle at which the laser light is incident upon the light incidence surface.

### FIELD OF THE INVENTION

The present invention relates to a solid-state-laser pumping module using a thin disk type of solid state laser medium, which is suitable for laser devices for laser radars and for machining, and a laser oscillator using the solid-state-laser pumping module.

### BACKGROUND OF THE INVENTION

The shapes of laser media for use in laser devices are categorized broadly into a rod type, a slab type, and a thin disk type. A rod type of laser medium is a laser medium which is formed like a rod so as to have a circular or polygonal shape in cross section. Laser light whose power is to be amplified by such a rod type of laser medium is made to pass through the laser medium so that it is incident upon one end surface of the laser medium and is passed through the laser medium toward another end surface of the laser medium along an optical axis perpendicular to the end surfaces of the laser medium, and it is amplified by the laser medium.

This structure has a feature of being easy to provide a large gain since the length over which the laser light propagates through the inside of the laser medium is long. Since the laser medium has a shape symmetric with respect to the optical axis, the structure also offers an advantage of being easy to obtain laser light having a symmetrical light intensity distribution.

Heat which is generated by the pumped laser medium of rod type is removed via an outer surface of the laser medium which serves as a cooling surface. For this reason, in the laser medium of rod type, a temperature distribution occurs in a cross section perpendicular to the optical axis thereof. This temperature distribution becomes a factor which provides malfunctions which vary according to the pumping power of the laser medium, such as a thermal lens effect, wave aberration, a thermal birefringence effect, to the laser medium.

To be more specific, the thermal lens effect changes beam modes, such as the beam size and divergence of laser light within a laser oscillator including the laser medium, because of the temperature gradient in the laser medium. The wave aberration reduces the oscillation efficiency of the laser oscillator by causing the laser light which goes around the inside of the laser oscillator to suffer a loss, and also reduces the beam quality of the laser light. The thermal birefringence effect reduces the degree of polarization of the laser light especially in a case of providing a laser oscillation of linearly polarized light. For these reasons, losses in the laser oscillator increase and the oscillation efficiency decreases, and hence the beam quality of the laser light degrades.

A slab type of laser medium is a laser medium which is formed into a trapezoidal shape in cross section. Heat which is generated by the pumped laser medium of slab type is removed from parallel opposing side surfaces which constitute the trapezoid of the slab type of laser medium, and which serve as cooling surfaces. Laser light which is incident upon the slab type of laser medium propagates through and is amplified by the slab type of laser medium while being reflected by the above-mentioned cooling surfaces a number of times.

This structure has a feature of being easy to provide a large gain since the length over which the laser light propagates through the inside of the laser medium is long. After reflected by the cooling surfaces a number of times, the incident laser light is outputted from the laser medium. For this reason, since a thermal lens effect which occurs in the direction of cooling is cancelled out, the change in the beam modes caused by the pumping power of the laser medium is small.

Furthermore, since the direction of cooling is only one direction, a temperature distribution theoretically occurs in only one direction of the laser medium. Therefore, a thermal birefringence within the laser medium has an axis in the direction of cooling and an axis in a direction perpendicular to the cooling direction. A slab type of laser medium therefore provides an advantage of being able to reduce changes in the polarization state of laser light which are caused by the thermal birefringence by causing light linearly polarized in the direction of each axis of the thermal birefringence to propagate through the laser medium.

However, in a slab type of laser medium, since incident laser light is reflected by the cooling surfaces of the laser medium a number of times, as mentioned above, the cooling surfaces need to have a high degree of flatness. Since the heat is actually removed from side surfaces other than the cooling surfaces, too, the temperature distribution of the laser medium which occurs due to the heat generated by the pumping is not associated with only one direction, and therefore the thermal lens effect is not necessarily cancelled out perfectly.

Therefore, even in a slab type of laser medium, changes in the beam modes can still occur due to changes in the pumping power of the laser medium which are caused by a thermal lens effect. A further problem is that since the degree of polarization of the laser light degrades due to a thermal birefringence within the laser medium, losses of the laser light increase and the oscillation efficiency of the laser device is therefore reduced.

A thin disc type of laser medium is a laser medium which is formed into a thin disk. In a thin disc type of laser medium, laser light is made to be incident upon one of two surfaces having the largest area of side surfaces which constitute the above-mentioned disk, and is amplified while being made to propagate along a direction of the thickness of the disk after reflected by the other surface having the largest area which is opposite to the light incidence surface.

Heat which is generated by the pumped laser medium of thin disc type is removed from the other surface which is opposite to the light incidence surface and which serves as a cooling surface. Since this structure provides a large cooling side surface, the heat removal is easily carried out as compared with the two other types of laser media. In addition, since the direction in which the heat is removed is parallel to the optical axis of the laser light, a thermal lens effect and a thermal birefringence effect are hardly produced. Thus, a thin disk type of laser medium has such a specific advantage which cannot be provided by any other type of laser medium having another shape.

On the other hand, a thin disc type of laser medium has the drawback of its gain decreasing with reduction in the thickness of the laser medium since the length within the laser medium over which incident laser light propagates is measured along the direction of the thickness of the disk. Furthermore, in order to acquire a larger gain with the same thickness and the same pumping power, a thin disk type of laser medium needs to increase the density of pumping light by reducing the disk diameter thereof and by condensing the pumping light.

However, since the cooling surface via which the generated heat is removed is reduced as the disk diameter is reduced, the efficiency of the cooling is reduced. Therefore, the density of heat generation increases when the pumping light is condensed to the laser medium having such the reduced disk diameter.

As a result, if the temperature of the laser medium rises too much when the laser medium is pumped, the laser medium itself may break thermally. Furthermore, in general, since a laser medium decreases in its gain with rise in the temperature thereof, the efficiency of amplification also decreases. In a thin disk type of laser medium, when using an end surface pumping method of causing pumping light to be incident upon the thin disk laser medium along the optical axis of laser light which is the direction of propagation of the laser light, the length propagated by the pumping light is limited by the thickness of the disk. A problem with such a thin disk type of laser medium is therefore that the efficiency of absorption of the pumping light by the laser medium cannot be increased sufficiently, and hence the oscillation efficiency of the laser device is reduced.

When a side pumping method of causing the pumping light to be incident upon the thin disk type of laser medium via a side surface parallel to the optical axis of the laser light is used instead of the above-mentioned end surface pumping method, a relatively long absorption length can be provided since the pumping light propagates along a direction of the diameter of the disk. However, the following malfunctions occur even when using the side pumping method.

Generally, in order that a laser oscillator using a thin disc type of laser medium can implement a high beam quality, the laser medium needs to have a disk diameter which is suited to a fundamental-mode beam diameter. Furthermore, in order that the laser oscillator can implement a high beam quality with stability, it is desirable that the fundamental-mode beam diameter is so small that no loss occurs in the laser oscillator.

For this reason, the disk diameter of a thin disc type of laser medium for use with a laser oscillator has to be reduced to as small as possible. However, the light incidence surface of the laser medium via which pumping light is incident upon the laser medium decreases inevitably with a reduction in the disk diameter, and it therefore becomes difficult to cause the pumping light to be incident upon the laser medium using the side pumping method. As a result, the influence of incidence loss of the pumping light becomes large, and this results in a reduction in the oscillation efficiency of the laser device on the contrary.

For example, when a high-power semiconductor laser (LD) in the form of an array is used, it is very difficult to cause pumping light outputted from a large light-emitting surface of the LD to be incident upon a disk side surface of a thin, small thin-disc-type laser medium.

JP,11-284257,A (referred to as patent reference 1 from here on) discloses a semiconductor-laser-pumping solid state laser apparatus using a tapered light guiding plate, as a technique for solving the above-mentioned malfunctions that can occur in a thin disc type of laser medium. This apparatus is characterized by using the tapered LD light transmission plate for transmitting pumping light outputted from an LD, and a solid state laser medium having much the same thickness as the LD light transmission plate, and having a disk shape such a circular or regular polygonal shape, as shown in FIG. 1 of patent reference 1.

The pumping light from the LD in the form of an array is incident upon a wider end surface of the tapered LD light transmission plate, the end surface having a width corresponding to the width of the LD in the direction of the array. The pumping light propagates through the tapered LD light transmission plate while being repeatedly total-reflected by side surfaces in the direction of the thickness of the LD light transmission plate and horizontally reflected by tapered side surfaces, and then converges to an emergence end surface having a width close to that of a TEM00 mode oscillation area of the solid state laser medium. The emergence end surface of the LD light transmission plate is in contact with a side surface of the thin disc laser medium, and the pumping light propagating through the inside of the LD light transmission plate pumps the solid state laser medium.

This structure makes it possible to make vertical components of the pumping light emitted out of the LD be total-reflected by the LD light transmission plate and hence to introduce them into the solid state laser medium with a high degree of efficiency. The above-mentioned structure also makes it possible to pump the solid state laser medium uniformly with a high pumping density since the pumping light can be converged uniformly in the horizontal direction so as to have a width close to that of the TE00 mode oscillation area.

However, the laser device disclosed by above-mentioned patent reference 1 does not solve all the above-mentioned malfunctions that can occur in a thin disc type of laser medium.

In the above-mentioned laser device, the pumping light is converged onto the thin disk solid state laser medium using the LD light transmission plate. When the disk diameter of the thin disc laser medium is reduced in order to make the laser device having this structure to laser-oscillate with stability, the density of heat caused by the pumping light becomes large inevitably, as mentioned above. Since a cooling surface also decreases in size as the light incidence surface decreases in size, the temperature rise of the laser medium at the time when pumped cannot be reduced. A problem with the above-mentioned laser device is therefore that a thermal breakage may occur in the laser medium.

Another problem is that since the above-mentioned temperature rise of the laser medium reduces the efficiency of absorption of the pumping light by the laser medium itself, and, when the laser medium is a three-level one, increase in the number of ions at a lower level, which contribute to the laser oscillation, lowers the gain of the laser medium, the oscillation efficiency of the laser device decreases.

In addition, in the laser device disclosed by patent reference 1, the laser light is vertically incident upon the light incidence surface of the thin disc laser medium. Therefore, since the length over which the laser light propagates through the laser medium is limited by the thickness of the disk, it cannot be expected that the laser medium provides a large gain.

Furthermore, when the disk diameter of the thin disc laser medium is reduced in order to make the laser device to laser-oscillate with stability, even a side pumping method cannot increase the total length over which the pumping light is made to pass through the laser medium. Therefore, another drawback of the related art thin disc laser medium is reduction in the efficiency of absorption of the pumping light and hence reduction in the efficiency of the laser device.

The present invention is made in order to solve the above-mentioned problems, and it is therefore an object of the present invention to provide a solid-state-laser pumping module and a laser oscillator which can suppress the temperature rise of a thin disc laser medium at the time of pumping of the thin disc laser medium, and can provide a high gain.

### DISCLOSURE OF THE INVENTION

In accordance with an aspect of the present invention, there is provided a solid-state-laser pumping module in accordance with the present invention includes a pumping medium member having a plate-shaped solid state laser medium that provides a gain generated by absorption of pumping light to laser light to amplify the laser light, a reflecting member disposed on a surface of the solid state laser medium which is opposite to a laser light incidence surface of the solid state laser medium, for reflecting the laser light which is incident upon the solid state laser medium via the light incidence surface and which propagates through the solid state laser medium, and a cooling member for removing heat which is transferred thereto, via the reflecting member, from the solid state laser medium, the laser light incidence surface of the solid state laser medium having a size of a in a direction perpendicular to a plane defined by both an optical axis of the laser light and a normal to the laser light incidence surface of the solid state laser medium, and a size of b in a longitudinal direction perpendicular to the direction and the normal, the sizes having a relationship given by b=a/cos θ, where θ is an incidence angle at which the laser light is incident upon the laser light incidence surface.

The solid-state-laser pumping module which is constructed as mentioned above has an advantage of being able to lengthen the length over which the laser light passes through the solid state laser medium compared with a case where the laser light is vertically introduced into the laser light incidence surface of the solid state laser medium, and hence to amplify the laser light with a high degree of efficiency.

In addition, in the solid-state-laser pumping module in accordance with the present invention, the laser light incidence surface of the solid state laser medium of the pumping medium member can have at least m regions (m is a positive integer) which are running along the longitudinal direction, each of the m regions having a size of a in the direction perpendicular to a plane defined by both the optical axis of the laser light and the normal to the laser light incidence surface of the solid state laser medium, and a size of b in the longitudinal direction perpendicular to the direction and the normal, the sizes having a relationship given by b=a/cosθ, where θ is the incidence angle at which the laser light is incident upon the laser light incidence surface, and the pumping module can include a reflecting mirror for successively reflecting the laser light reflected by the reflecting member toward the solid state laser medium so that the laser light is incident upon the solid state laser medium m times at the incidence angle θ.

The solid-state-laser pumping module which is constructed as mentioned above has an advantage of being able to amplify the laser light with a higher degree of efficiency compared with the above-mentioned solid-state-laser pumping module.

Furthermore, in the solid-state-laser pumping module in accordance with the present invention, the pumping medium member can include solid state laser media arranged at locations thereof upon which the laser light which is successively reflected by the reflecting mirror is successively incident, and a slab waveguide member for connecting the solid state laser media to one another, and for making the pumping light pass through the solid state laser media.

The solid-state-laser pumping module which is constructed as mentioned above has an advantage of being able to decentralize the temperature rise of the solid state laser medium at the time of pumping, and hence to suppress occurrence of malfunctions due to an extreme temperature rise of the solid state laser medium.

In accordance with another aspect of the present invention, there is provided a solid-state-laser pumping module including: a plurality of pumping medium members each including a plate-shaped solid state laser medium that provides a gain generated by absorption of pumping light to laser light to amplify the laser light, a reflecting member disposed on a surface of the solid state laser medium which is opposite to a laser light incidence surface of the solid state laser medium, for reflecting the laser light which is incident upon the solid state laser medium via the light incidence surface and which propagates through the solid state laser medium, and a cooling member for removing heat which is transferred thereto, via the reflecting member, from the solid state laser medium, the laser light incidence surface of the solid state laser medium having a size of a in a direction perpendicular to a plane defined by both an optical axis of the laser light and a normal to the laser light incidence surface of the solid state laser medium, and a size of b in a longitudinal direction perpendicular to the direction and the normal, the sizes having a relationship given by b=a/cos θ, where θ is an incidence angle at which the laser light is incident upon the laser light incidence surface, and the plurality of pumping medium members being arranged so that each of the plurality of pumping medium members outputs the laser light which is amplified by the solid state laser medium thereof and is reflected by the reflecting member thereof as output light, and so that the output light from each of the plurality of pumping medium members arranged at a preceding stage is incident upon another one of the plurality of pumping medium members arranged at a next stage and the laser light is successively amplified by the plurality of pumping medium members.

The solid-state-laser pumping module which is constructed as mentioned above has an advantage of being able to suppress the temperature rise of the plate-shaped solid state laser medium at the time of pumping of the plate-shaped solid state laser medium, and to provide a gain which is higher than that provided by the above-mentioned solid-state-laser pumping module to the laser light is to be amplified.

In accordance with a further aspect of the present invention, there is provided a laser oscillator including: a pumping medium member including a plurality of plate-shaped solid state laser media which provide their respective gains generated by absorption of pumping light to plural beams of laser light to amplify the plural beams of laser light, a reflecting member disposed on surfaces of the plurality of the solid state laser media which are opposite to laser light incidence surfaces of the plurality of solid state laser media, for reflecting the plural beams of laser light which are incident upon the plurality of solid state laser media via the light incidence surfaces and which propagate through the plurality of solid state laser media, respectively, and a cooling member for cooling which is transferred thereto, via the reflecting member, from the plurality of solid state laser media, the plurality of solid state laser media being arranged at locations of the pumping medium member upon which the plural beams of laser light are incident, respectively, and the plurality of solid state laser media being connected to one another via a slab waveguide member which makes the pumping light propagate through the plurality of solid state laser media; and an optical system for repeatedly making the plural beams of laser light be incident upon the plurality of solid state laser media of the pumping medium member, respectively, and making the plural beams of laser light reflected from the reflecting member be re-incident upon the plurality of solid state laser media of the pumping medium member, respectively, so as to cause laser oscillations.

The solid-state-laser pumping module which is constructed as mentioned above has an advantage of being able to suppress the temperature rise of each of the plurality of plate-shaped solid state laser media at the time of pumping of each of the plurality of plate-shaped solid state laser medium, and to provide a high gain to each of the plural beams of laser light which is to be amplified, thereby providing a high-efficiency high-power laser device.

### BRIEF DESCRIPTION OF THE FIGURES

FIG. 1A is a view showing the structure of a solid-state-laser pumping module in accordance with embodiment 1 of the present invention, and FIG. 1B is a side view of the solid-state-laser pumping module shown in FIG. 1A when viewed from a direction of the x-axis of the solid-state-laser pumping module;

FIG. 2A is an xy plan view showing a structure in which each of LDs for pumping applies pumping light directly to a solid state laser medium, and FIG. 2B is an xy plan view showing a structure in which each of LDs for pumping applies pumping light to a solid state laser medium via a slab waveguides which is so formed as to have tapered side surfaces;

FIG. 3A is a view showing a cross section in an xz plane of the solid-state-laser pumping module shown in FIG. 1, and FIG. 3B is a view showing a cross section in a yz plane of the solid-state-laser pumping module shown in FIG. 1;

FIG. 4 is a diagram showing the structure of a solid-state-laser pumping module in accordance with embodiment 2 of the present invention;

FIG. 5A is a view showing the structure of a solid-state-laser pumping module in accordance with embodiment 3 of the present invention, and FIG. 5B is a side view of the solid-state-laser pumping module shown in FIG. 5A when viewed from a direction of the x-axis of the solid-state-laser pumping module;

FIG. 6 is a diagram showing the structure of a solid-state-laser pumping module in accordance with embodiment 4 of the present invention;

FIG. 7A is a diagram showing the structure of a thin disk solid state laser medium in accordance with embodiment 5 of the present invention, and FIG. 7B is a cross-sectional view in an xz plane showing the structure of a solid-state-laser pumping module in accordance with embodiment 5 of the present invention;

FIGS. 8A to 8H are plan views each showing the structure of a pumping medium member; and

FIG. 9 is a diagram showing the structure of a laser device which uses a solid-state-laser pumping module in accordance with embodiment 6 of the present invention.

### PREFERRED EMBODIMENTS OF THE INVENTION

In order to explain the invention in greater detail, the preferred embodiments of the invention will be explained below with reference to the accompanying figures.

Embodiment 1.

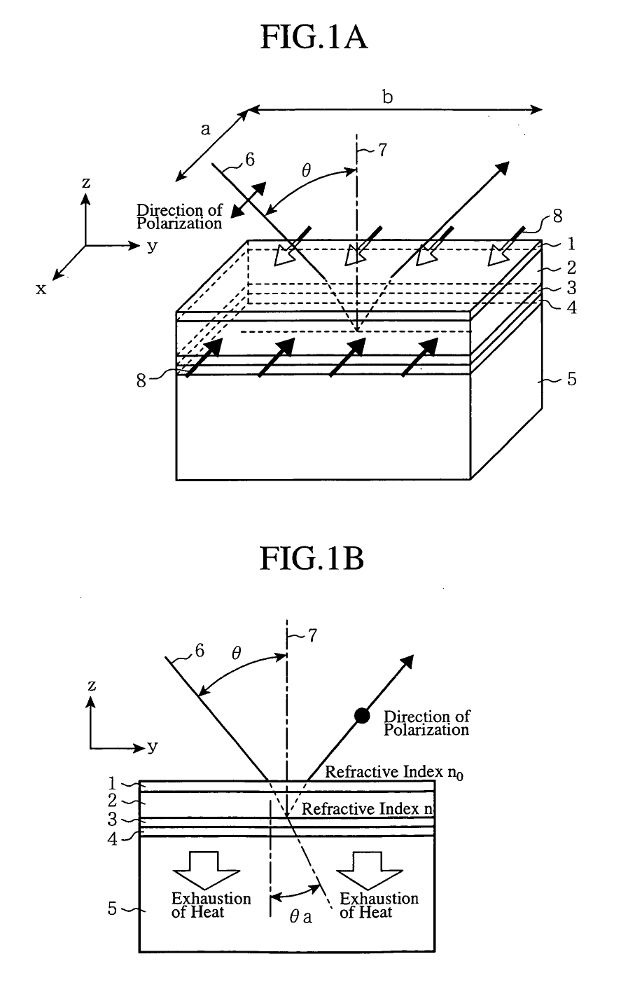

FIG. 1A is a view showing the structure of a solid-state-laser pumping module in accordance with embodiment 1 of the present invention, and FIG. 1B is a side view of the solid-state-laser pumping module shown in FIG. 1A when viewed from a direction of the x-axis of the solid-state-laser pumping module. In the solid-state-laser pumping module shown in FIG. 1, a total reflection coating 3 is bonded, via a bonding agent 4, onto a heat sink 5, a thin disk-shaped solid state laser medium 2 is formed on the total reflection coating 3, and an antireflection coating 1 is formed on the thin disk-shaped solid state laser medium.

The antireflection coating 1 causes almost all of laser light 6 incident thereupon at an incidence angle θ to pass therethrough toward the solid state laser medium 2. The antireflection coating 1 can be constructed of, for example, dielectric thin films laminated. As the solid state laser medium 2, a typical solid state laser medium can be used.

For example, Nd:YAG, Nd:YLF, Nd:YVO₄, Nd:Glass, Yb:YAG, Yb:YLF, Er:Glass, Er:YAG, Tm:YAG, Tm:YLF, Ho:YAG, Ho:YLF, Tm, Ho:YAG, Tm, Ho:YLF, Ti:Sapphire, Cr:LiSAF, or the like is used.

In FIG. 1A, there is provided a rectangular coordinate system in which a direction perpendicular to a plane including the optical axis of the laser light 6 and the normal 7 to a light incidence surface of the solid state laser medium 2 is defined as the x axis, the direction of the normal 7 is defined as the z-axis, and the direction of the normal to an xz plane is defined as the y-axis. This rectangular coordinate system is similarly defined in the subsequent drawings.

The above-mentioned light incidence surface of the solid state laser medium 2 upon which the laser light 6 is incident is shaped like a rectangle having a size of a in the direction of the x-axis and a size of b in the direction of the y-axis, and a relationship between these sizes is given by the following equation (1):
b=a/cos θ (1)

That is, the laser light 6 is incident upon the light incidence surface of the solid state laser medium 2 at an incidence angle θ which makes an irradiated area on the light incidence surface of solid state laser medium 2 be larger than the cross-sectional area of the laser light 6 (i.e., the cross-sectional area in a cross section perpendicular to the optical axis of the laser light).

In this case, as compared with a case where the laser light 6 is vertically incident upon the light incidence surface of the solid state laser medium 2, the length over which the laser light propagates through the solid state laser medium 2 can be lengthened and therefore the efficiency of laser amplification can be raised.

As shown in FIG. 1B, the total reflection coating 3 reflects almost all of the laser light 6 which is incident upon the solid state laser medium 2 at the incidence angle θ and is then incident thereupon at an incidence angle θₐ due to refraction in the solid state laser medium. The total reflection coating 3 can be formed by laminating a plurality of dielectric thin coatings, or using vapor deposition of a metallic film. The bonding agent 4 can be formed of metallic solder or an adhesive.

The incidence angle θₐ at which the laser light 6 is incident upon the total reflection coating 3 under the influence of the refraction in the solid state laser medium 2 is given by the following equation:
θₐ=sin ⁻¹(n₀ sin θ/n) (2)
where n is the refractive index of the solid state laser medium 2, and n₀ is the refractive index of a medium through which the laser light 6 has propagated before entering the solid state laser medium 2.

Next, the operation of the solid-state-laser pumping module in accordance with this embodiment of the present invention will be explained.

Pumping light 8 which is incident upon a side surface of the solid state laser medium 2 propagates through the inside of the solid state laser medium while being reflected by inner surfaces of the solid state laser medium 2. As a result, the solid state laser medium 2 absorbs the pumping light 8 to generate a gain.

The laser light 6 which is the target whose power is to be amplified is incident upon the solid state laser medium 2 at an incidence angle θ, and is amplified by the solid state laser medium 2 until it reaches the total reflection coating 3 after passing through the antireflection coating 1. The laser light 6 which is amplified by the solid state laser medium 2 until it reaches the total reflection coating 3 is reflected by the total reflection coating 3, and is further amplified when passing through the inside of the solid state laser medium 2 again. Then, the laser light 6 passes through the antireflection coating 1 and emerges from the solid-state-laser pumping module.

Heat which is generated when the solid state laser medium 2 is pumped by the pumping light is transferred, via the total reflection coating 3 and bonding agent 4, to the heat sink 5. The heat sink 5 is cooled by, for example, cooling water, an air cooling fan, or the like so that rises in the temperature of the solid state laser medium 2 can be suppressed.

Since the heat is removed in the direction of the -z-axis, as shown in FIG. 1B, the solid state laser medium 2 has thermal birefringence having two birefringence axes: an axis running in the direction of the z-axis and an axis existing in an xy plane and running in a direction perpendicular to the optical axis of the laser light 6. This thermal birefringence provides a birefringence effect having two axes: an axis existing in a plane including the optical axis of the laser light and the z-axis and running in a direction perpendicular to the above-mentioned optical axis, and an axis existing in an xy plane and running in a direction perpendicular to the above-mentioned optical axis to the laser light 6 incident upon the solid state laser medium at the incidence angle θ.

The birefringence effect generates different refractive indexes for electric field components in the directions of the above-mentioned two axes, respectively, and provides different phase changes for the electric field components in the directions of the above-mentioned two axes, respectively. For this reason, when the laser light 6 incident upon the solid state laser medium 2 has electric field components in the directions of the above-mentioned two axes, the polarization status of the laser light 6 which passes through, is amplified by, and emerges from the solid state laser medium 2 changes due to the above-mentioned birefringence effect.

When the solid-state-laser pumping module which produces the above-mentioned birefringence effect is used as a laser oscillator, determination of the direction of the polarization of the laser light 6 whose power is to be amplified regardless of the birefringence axes causes the laser oscillator to oscillate in different resonance modes for the directions of the above-mentioned two axes. For this reason, it becomes difficult for the laser light 6 to have a high beam quality.

In accordance with the present invention, in order not to change the polarization status of the laser light 6 according to the above-mentioned birefringence effect, linearly polarized light which is polarized in the direction of one of the birefringence axes, i.e., linearly polarized light (S-polarized light) which is polarized in a direction (i.e., the direction of the x-axis) perpendicular to a plane including the optical axis of the laser light 6 and the normal 7, or linearly polarized light (P-polarized light) which is polarized in a direction existing in a plane including the optical axis of the laser light 6 and the normal 7, and perpendicular to the optical axis is incident upon the solid-state-laser pumping module as the laser light 6.

FIG. 1 shows a case where S-polarized light is incident upon the solid-state-laser pumping module as the laser light 6. A black dot mark shown on the optical axis of the laser light 6 shown in FIG. 1B indicates the direction of the polarization of the laser light 6, and shows that the laser light is polarized in a direction perpendicular to the figure, i.e., the laser light is S-polarized light.

Thus, the solid-state-laser pumping module provided with the thin disk-shaped laser medium 2 in accordance with the present invention can be used as a laser oscillator without a hitch since the polarization status of the laser light 6 does not change due to the birefringence effect even after amplified.

A total reflection mirror for reflecting the laser light 6 and a partial reflection mirror for reflecting a part of the laser light 6, and for allowing a remaining part of the laser light to pass therethrough, which are not shown, are prepared, and either the total reflection mirror or the partial reflection mirror is disposed on the optical axis of the laser light 6 which has not yet been incident upon the solid-state-laser-medium 2 and either the partial reflection mirror or the total reflection mirror is disposed on the optical axis of the laser light 6 which has passed through the solid state laser medium 2 and has emerged from the solid-state-laser pumping module of the present invention.

A laser cavity in which the laser light 6 laser-oscillates within a path which consists of the above-mentioned total reflection mirror, the solid-state-laser pumping module in accordance with the present invention, and the above-mentioned partial reflection mirror can be thus constructed. As a result, the above-mentioned laser cavity can be used as a laser device which outputs the laser light 6 amplified thereby, via the above-mentioned partial reflection mirror, toward outside the laser cavity.

At this time, by making either the antireflection coating 1 or the total reflection coating 3 have different characteristics for S-polarized light and P-polarized light, the direction of the polarization of the laser light 6 which is generated by the above-mentioned laser cavity can be restricted to either S polarization or P polarization. Therefore, the laser light 6 which is linearly polarized can be obtained as output light even if the direction of the polarization of the laser light 6 incident upon the above-mentioned laser cavity is not specified beforehand.

When an optical component, such as a polarizer, for restricting the direction of the polarization of the laser light 6 to a direction which matches with one of the birefringence axes is arranged in the above-mentioned laser cavity, the laser light 6 which is linearly polarized can be obtained as output light even if either the antireflection coating 1 or the total reflection coating 3 is not made to have the above-mentioned characteristics for S-polarized light and P-polarized light.

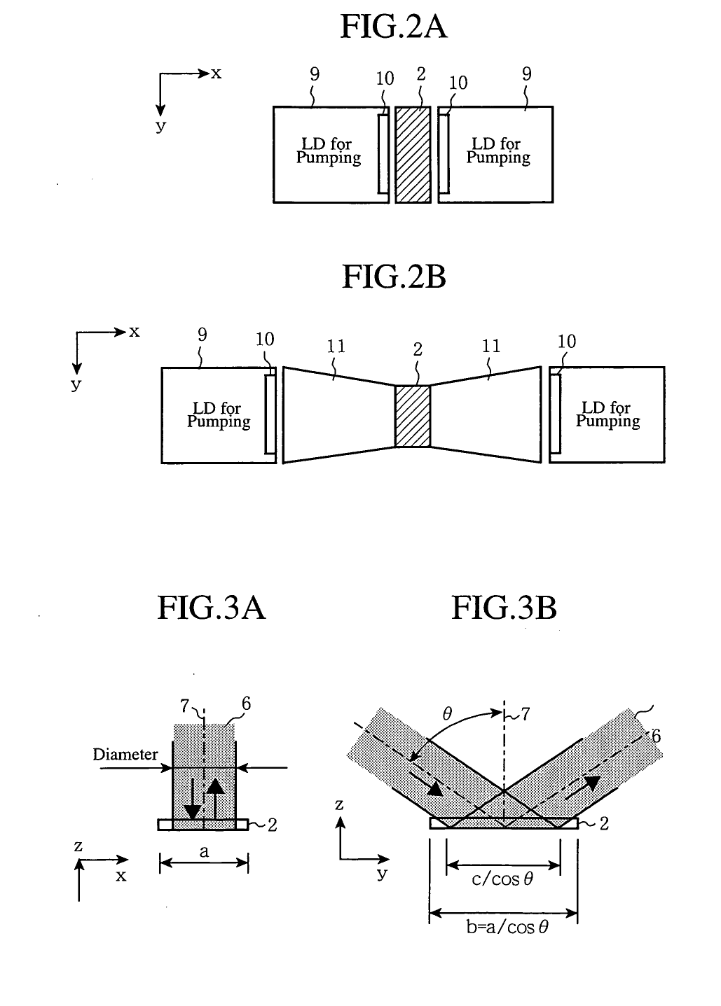

Next, an example of a method of making the pumping light 8 be incident upon the solid state laser medium 2 of the solid-state-laser pumping module shown in FIG. 1 will be explained with reference to FIGS. 2A and 2B. In these figures, the antireflection coating 1 is not shown in order to make a relationship between the solid state laser medium 2 and other components be clear.

FIG. 2A is an xy plan view showing a structure in which each of LDs 9 for pumping applies the pumping light 8 directly to the solid state laser medium 2. This structure is effective for a case where the light incidence surface of the solid state laser medium 2 via which the pumping light 8 is incident upon the solid state laser medium 2 has a width which is the same as or a little larger than the width in the direction of the y-axis of each LD 9 for pumping. Each LD 9 for pumping emits out the pumping light 8 as shown by FIG. 1 from a light emitting unit 10 thereof.

The light emitting unit 10 has a width of several micrometers in the direction of the x-axis and a length of several millimeters in the direction of the y-axis. When the light incidence surface of the solid state laser medium 2 via which the pumping light 8 is incident upon the solid state laser medium 2 has a width which is the same as or larger than the length of the light emitting unit 10 in the direction of the y-axis, each LD 9 for pumping is arranged so as to be close to the solid state laser medium 2, as shown in FIG. 2A. As a result, almost all of the pumping light 8 from each LD 9 for pumping can be made to be incident upon the solid state laser medium 2.

FIG. 2B is an xy plan view showing a structure in which the pumping light 8 from each LD for pumping is made to be incident upon the solid state laser medium 2 via a slab waveguide 11 which is so formed as to have tapered side surfaces. This structure shown in FIG. 2B is effective for a case where the light incidence surface of the solid state laser medium 2 via which the pumping light 8 is incident upon the solid state laser medium 2 has a width smaller than the length in the direction of the y-axis of the light emitting unit 10 of each LD for pumping.

Each slab waveguide 11 has much the same thickness as the solid state laser medium 2, and makes the pumping light 8 from each LD 9 for pumping be incident upon the solid state laser medium 2 while condensing the pumping light 8 in the direction of the y-axis.

In other words, in each slab waveguide 11 which is so formed as to have tapered side surfaces, the cross-sectional area of the slab waveguide (i.e., the cross-sectional area in a cross section parallel to an incidence end surface of the slab waveguide 11 via which the pumping light 8 from each LD 9 for pumping is incident upon the slab waveguide) decreases gradually with distance from the incidence end surface of the slab waveguide 11 toward another end surface from which the pumping light 8 emerges toward the solid state laser medium 2. Therefore, each slab waveguide makes the pumping light 8 be incident upon the solid state laser medium 2 while condensing the pumping light 8.

As a result, a high degree of efficiency of making the pumping light 8 be incident upon the solid state laser medium 2 can be provided.

The solid state laser medium 2 and each slab waveguide 11 are optically bonded to each other using an optical contact method or the like. The optical contact method is a method of polishing the bonding surfaces of the solid state laser medium 2 and the slab waveguides 11 with a high degree of precision, and bonding the slab waveguides to the solid state laser medium.

There is another method of optically bonding the solid state laser medium 2 and the slab waveguides 11, which have been already optically bonded to each other using an optical contact method, to each other using diffusion bonding, which is intended for strengthening the bonding strength, by heating them while applying a pressure to them. As an alternative, crystal grains of the solid state laser medium 2 and crystal grains of the slab waveguides 11 are formed, and are hardened by sintering into a ceramic in which the solid state laser medium 2 and the slab waveguides 11 are integrally formed

Next, a relationship in size between the solid state laser medium 2 and the laser light 6 for a case where the laser light 6 which is assumed to have a circular shape (have a diameter of c) in a cross section perpendicular to the optical axis thereof is incident upon the solid state laser medium 2 at an incidence angle θ will be explained with reference to FIGS. 3A and 3B. In these figures, the antireflection coating 1 and other components are not shown in order to make the relationship in size between the solid state laser medium 2 and the laser light 6 be clear.

FIG. 3A is a view showing a cross section in an xz plane of the solid-state-laser pumping module shown in FIG. 1, and FIG. 3B is a view showing a cross section in a yz plane of the solid-state-laser pumping module shown in FIG. 1. As shown in FIGS. 3A and 3B, the laser light 6 which is circular in a cross section perpendicular to the optical axis thereof and has a diameter of c is incident upon the light incidence surface of the solid state laser medium 2 with an elliptical shape having a minor axis c in the direction of the x-axis and a major axis c/cos θ in the direction of the y-axis.

In order to efficiently take out the power stored in the solid state laser medium 2, it is desirable that the ratio of the beam diameter of the laser light 6 and the size of the solid state laser medium 2 is constant. When the ratio of the diameter c of the laser light 6 and the size a of the solid state laser medium 2 in the direction of the x-axis is a/c=r, the relationship in size between the laser light 6 and the solid state laser medium 2 at the light incidence surface of the solid state laser medium 2 is given by both the ratio of the laser light 6 and the solid state laser medium 2 in the direction of the x-axis: a/c=r, and the ratio of the laser light 6 and the solid state laser medium 2 in the direction of the y-axis: (a/cos θ)/(c/cos θ)=a/c=r.

Therefore, when the solid state laser medium 2 is constructed so that above-mentioned equation (1) is satisfied, it is possible to keep the same ratio for both the direction of the x-axis and the direction of the y-axis and it is also possible to efficiently take out the power stored in the solid state laser medium 2.

It is known that the size a has only to be set so that a/c falls within a range of 1 to 1.7 in order to selectively amplify TEM00 light having a diffraction limit using an aperture having a diameter of a, and it is desirable that a/c is equal to about 1 in order to amplify the laser light 6 of multimode including a high-order mode.

In a thin disc type of solid state laser medium, power which can be stored per unit area, i.e., pumping light incidence power per unit area is restricted to a power limit determined by thermal breakages caused by the temperature rise of the solid state laser medium. Therefore, in order to obtain a large laser output, it is necessary to enlarge the area of the solid state laser medium 2.

However, the beam diameter of the laser light 6 when passing through the laser cavity is determined by the stability condition of the laser cavity. Particularly, when the beam diameter is enlarged in order to provide a beam quality of diffraction limit, the laser cavity needs to have a long length. However, as the laser cavity is enlarged, it easily becomes unstable.

In contrast, in accordance with the present invention, by increasing the incidence angle θ while keeping the beam diameter of the laser light 6 constant, the area of the solid state laser medium 2 can be increased and the power stored in the whole of the solid state laser medium 2 can be increased. As a result, a stable laser cavity which implements high power and a beam quality of diffraction limit can be constructed.

In the solid state laser medium 2, when the pumping light incidence power per unit area is set to constant, the stored power is proportional to 1/cos θ. For example, the stored power increases by a factor of 1.4 when the incidence angle θ is 45 degrees, increases by a factor of 2 when the incidence angle θ is 60 degrees, and increases by a factor of 3.8 when the incidence angle θ is 75 degrees. When the incidence angle θ is nearly 0 degrees, the increase in the stored power is small. Therefore, it is desirable that the incidence angle is 45 degrees or more.

In general, the gain provided to the laser light 6 by the solid state laser medium 2 is proportional to the length over which the laser light 6 passes through the inside of the solid state laser medium 2. It is however difficult for a thin disk type of solid state laser medium to provide a sufficient gain since it has a thin thickness.

In contrast, in accordance with the present invention, the length over which the laser light 6 passes through the inside of the solid state laser medium 2 can be increased by increasing the incidence angle θ, and therefore the gain provided to the laser light 6 can be increased.

For example, when YLF (LiYF₄ of refractive index of 1.45) is used as a host material of the solid state laser medium 2, the length over which the laser light 6 passes through the inside of the solid state laser medium 2 is proportional to 1/cos θₐ. That is, the length over which the laser light 6 passes through the inside of the solid state laser medium 2 increases by a factor of about 1.15 when the incidence angle θ is 45 degrees, increases by a factor of about 1.25 when θ is 60 degrees, and increases by a factor of about 1.34 when θ is 75 degrees, as compared with what it is when θ is 0 degrees. The rate of increase in the length over which the laser light passes through the inside of the solid state laser medium increases with decrease in the refractive index of the host material.

Furthermore, when the incidence angle θ is a Brewster angle (θ=tan ⁻¹ (n/n₀)) for the solid state laser medium 2, and the laser light 6 is linearly polarized light (i.e., P-polarized light) which is polarized in a plane including the optical axis of the laser light and the normal 7, no reflection of the laser light 6 occurs on the light incidence surface of the solid state laser medium 2. Therefore, the antireflection coating 1 can be omitted. As a result, losses of the laser light due to the antireflection coating 1 which occur when the laser light is incident upon the solid state laser medium 2 can be reduced. Since the antireflection coating 1 can be omitted, the laser device can be manufactured at a low cost.

In a case where a dielectric multilayer film is used as the total reflection coating 3, when the laser light 6 is linearly polarized light (i.e., S-polarized light) which is polarized in a direction perpendicular to a plane including the optical axis and the normal 7, the thickness of the total reflection coating 3 can be thinned compared with a case where the laser light 6 is P-polarized light. The thermal resistance of the total reflection coating 3 is nearly proportional to the thickness of the total reflection coating. Therefore, when the total reflection coating 3 is constructed as mentioned above, the thermal resistance of the total reflection coating 3 can be reduced and the temperature rise of the solid state laser medium 2 can also be suppressed.

In general, the efficiency of the solid state laser medium decreases with a rise in the temperature of the solid state laser medium. In accordance with the present invention, when the power stored in the whole of the solid state laser medium 2 is set to constant, the incidence angle θ is increased in order to increase the area of the solid state laser medium 2.

As a result, since the amount of generated heat per unit area of the solid state laser medium 2 decreases, the temperature rise of the solid state laser medium 2 can be suppressed and the efficiency of the laser device can be improved.

Generally, a bonding agent, especially an organic bonding agent, has a low maximum working temperature, and is difficult to use for fixation of the high-power solid state laser medium 2 in which the heat density is large.

In accordance with the present invention, the incidence angle θ can be increased in order to increase the area of the solid state laser medium 2, and hence to decrease the amount of generated heat per unit area of the solid state laser medium 2.

Some organic bonding agents as mentioned above can bond bonding surfaces of components which are to be bonded to each other to each other while covering minute projections and depressions which exist in the bonding surfaces.

When such a bonding agent is used as the bonding agent 4, the antireflection coating 1, solid state laser medium 2, and total reflection coating 3 can be easily fixed to the heat sink 5 even if the heat sink 5 has a low degree of flatness.

When a bonding agent which is softer than the solid state laser medium 2, i.e., which has a higher degree of softness than the solid state laser medium 2 is used as the bonding agent 4, it can also be expected that the bonding agent serves as a shock absorbing material that lessens stress to the solid state laser medium 2.

In addition, when either metallic solder or a thermally conductive bonding agent is used as the bonding agent 4, the bonding agent 4 absorbs the pumping light 8. For this reason, when either the laser light 6 or the pumping light 8 leaks toward the bonding agent 4, a temperature rise of the bonding agent 4 and lowering of the bonding strength due to the temperature rise may occur, and gasses emerging from the bonding agent 4 may put contaminants on optical components, and may cause damage or the like to them.

Therefore, when using either metallic solder or a thermally conductive bonding agent as the bonding agent 4, the total reflection coating 3 needs to total-reflect both the laser light 6 and the pumping light 8 simultaneously. Generally, a high-power semiconductor laser (LD) is used as the pumping light source.

Generally, the pumping light outputted from this semiconductor laser (LD) has a large divergence, and is incident upon the total reflection coating 3 at various angles. For this reason, in order to implement a high degree of reflectivity, the structure of the total reflection coating becomes complicated inevitably, and the thickness of the total reflection coating must be increased. Since the thermal resistance of the total reflection coating 3 is nearly proportional to the thickness of the total reflection coating 3, the temperature of the laser medium 2 increases with increase in the thickness of the total reflection coating 3.

Therefore, in accordance with the present invention, instead of using either metallic solder or a thermally conductive bonding agent as the bonding agent 4, an optical bonding agent having a refractive index which causes the pumping light 8 to satisfy the total reflection condition when passing through the solid state laser medium 2 and having a property of little absorption of the pumping light 8 can be used.

When YAG (Y₃Al₅O₁₂ having a refractive index of 1.82) is used as the host material of the solid state laser medium 2 and an optical bonding agent having a refractive index of 1.6 is used as the bonding agent 4, the pumping light 8 which is diverged up to 120 degrees at full width in the outside of the solid state laser medium 2 can be confined in the laser cavity by the total reflection.

In this case, since the pumping light 8 is confined within the laser cavity by the total reflection by the inner surfaces of the solid state laser medium 2, losses of the pumping light 8 can be reduced and the efficiency of the solid-state-laser pumping module can be improved.

Although the pumping light 8 can be absorbed by the bonding agent 4 in a case of using either metallic solder or a thermally conductive bonding agent as the bonding agent 4, since when an optical bonding agent is used as the bonding agent, the pumping light 8 is not absorbed by the optical bonding agent, the total reflection coating 3 does not need to have a function of total-reflecting the pumping light 8. For this reason, it becomes easy to design the total reflection coating and the thickness of the total reflection coating can be thinned.

The optical bonding agent has a large thermal resistance compared with thermally conductive bonding agents. On the other hand, filler (i.e., a small metallic fiber) or the like, which is used for reducing the thermal resistance of a thermally conductive bonding agent, is not contained in the optical bonding agent.

For this reason, when an optical bonding agent is used as the bonding agent 4, the thickness of the bonding agent 4 can be thinned and the thermal resistance of the combination of the bonding agent 4 and the total reflection coating 3 can be reduced.

As shown in FIG. 1A, in accordance with this embodiment, the pumping light 8 is incident upon the solid state laser medium 2 via each of side surfaces of the solid state laser medium 2 which are parallel to an xy plane. Since the solid-state-laser pumping module is thus constructed, the length of absorption of the pumping light 8 can be adjusted according to the size a of the solid state laser medium in the direction of the x-axis, and all the power stored in the solid state laser medium 2 can be adjusted according to the size b of the solid state laser medium in the direction of the y-axis.

As a result, the absorbed amount of the pumping light 8 by the solid state laser medium 2 and required power stored in the solid state laser medium 2 can be designed independently. Since side surfaces having a wider width are selected, as the pumping light incidence surfaces, from among the side surfaces which constitute the disk of the solid state laser medium 2, the pumping light 8 can be easily incident upon the solid state laser medium 2.

FIG. 1 shows the example in which the pumping light 8 is incident upon the solid state laser medium 2 via the side surfaces of the solid state laser medium 2 which are parallel to an xy plane. As an alternative, the pumping light 8 can be incident upon the solid state laser medium 2 via other side surfaces of the solid state laser medium 2 which are parallel to an xz plane. In this case, since a longer length of absorption of the pumping light is obtained with respect to the direction of the y-axis of the solid state laser medium 2, a high degree of absorption efficiency is acquired even if a laser medium material of small absorption of the pumping light is used.

Since the length of absorption of the pumping light 8 of the solid state laser medium 2 can be varied with the ratio of the size of the laser light incidence surface in the direction of the x-axis and the size of a region irradiated by the laser light 6 on the laser light incidence surface being fixed, the absorbed amount of the pumping light 8 by the solid state laser medium 2 and the beam diameter of the laser light can be designed independently.

In above-mentioned embodiment 1, the example in which the solid state laser medium 2 satisfies above-mentioned equation (1) in size is shown. It is apparent from the above description that almost the same advantages are acquired when the solid state laser medium 2 satisfies the following relationship: b>a in size.

Especially, in a case where the laser light 6 is not circular in cross section, but is elliptical or rectangular in cross section, when the ratio of the size of the region irradiated by the laser light 6 on the laser light incidence surface of the solid state laser medium 2 and the size of the laser light incidence surface of the solid state laser medium 2 is set so that it has the same value for both the direction of the x-axis and the direction of the y-axis, the power stored in the solid state laser medium 2 can be taken out efficiently.

In the example shown in FIG. 1, the laser light incidence surface of the solid state laser medium 2 is a rectangle having a size of a in the direction of the x-axis, and a size of b in the direction of the y-axis direction. In accordance with the present invention, the laser light incidence surface of the solid state laser medium 2 is not limited to such a rectangle. For example, the laser light incidence surface of the solid state laser medium 2 can be an ellipse having a minor axis a in the direction of the x-axis, and a major axis b in the direction of the y-axis.

When the solid state laser medium is constructed in this way, the ratio of the size of the region irradiated by the laser light 6 on the laser light incidence surface of the solid state laser medium 2 and the size of the laser light incidence surface of the solid state laser medium can have the same value not only for both the direction of the x-axis and the direction of the y-axis direction, but also for all directions in an xy plane.

As a result, the size of the region irradiated by the laser light 6 and the size of the solid state laser medium become nearly equal, the power stored in the solid state laser medium 2 can be taken out more efficiently.

Embodiment 2.

The pumping module, as shown in FIG. 1, in accordance with above-mentioned embodiment 1 needs to restrict the direction of the polarization of the laser light 6 incident upon the solid state laser medium 2 to either S-polarization or P-polarization because of the thermal birefringence which occurs in the solid state laser medium 2. This embodiment 2 offers a structure which removes the above-mentioned restriction.

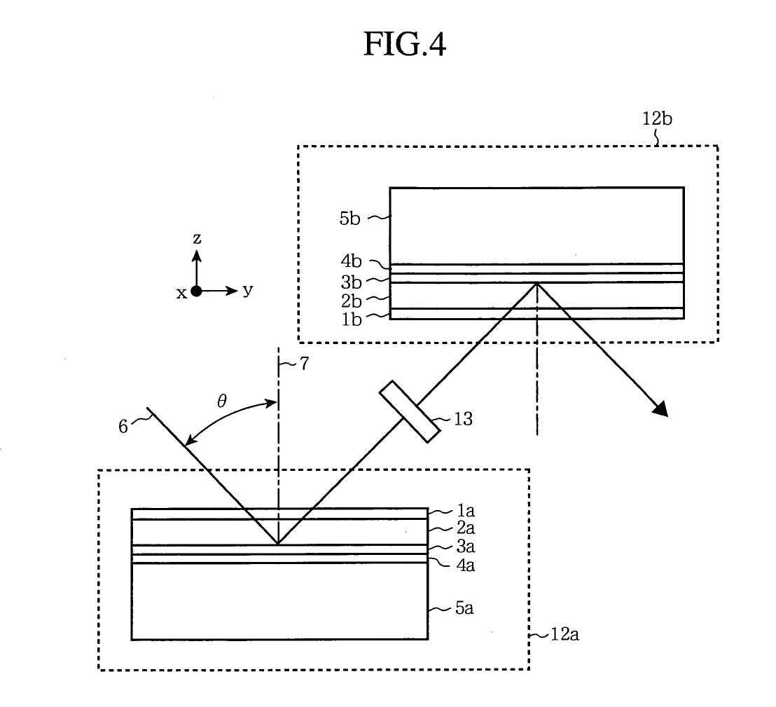

FIG. 4 is a diagram showing the structure of a solid-state-laser pumping module in accordance with embodiment 2 of the present invention. The solid-state-laser pumping module units 12a and 12b includes total reflection coatings 3a and 3b which are bonded, via bonding agents 4a and 4b, onto heat sink 5a and 5b, respectively, thin disk-shaped solid state laser media 2a and 2b which are formed on the total reflection coatings 3a and 3b, respectively, and antireflection coatings 1a and 1b which are formed on the thin disk-shaped solid state laser media, respectively.

The functions of the antireflection coating 1a, solid state laser medium 2a, total reflection coating 3a, bonding agent 4a, and heat sink 5a are the same as those of the antireflection coating 1, solid state laser medium 2, total reflection coating 3, bonding agent 4, and heat sink 5 which are shown in FIG. 1, respectively. A polarization rotator 13 rotates the polarization of incident laser light 6 by 90 degrees, and a quartz rotator, a ½ wavelength plate, or the like can be used as the polarization rotator 13.

Next, the operation of the combination of the solid-state-laser pumping module in accordance with this embodiment of the present invention will be explained.

Laser light 6 which is incident upon the first solid-state-laser pumping module unit 12a at an incidence angle θ is amplified when passing through a path extending from the antireflection coating la, via the solid state laser medium 2a, to the total reflection coating 3a, is reflected by the total reflection coating 3a, and is amplified again when passing through a path extending from the total reflection coating, via the solid state laser medium 2a, to the antireflection coating 1a. The laser light 6 then emerges from the first solid-state-laser pumping module unit.

The laser light 6 emerging from the first solid-state-laser pumping module unit 12a is then incident upon the second solid-state-laser pumping module unit 12b after the polarization of the laser light is rotated by the polarization rotator 13 by 90 degrees.

The laser light 6 which is incident upon the second solid-state-laser pumping module unit 12b via the polarization rotator 13 is amplified when passing through a path extending from the antireflection coating 1b, via the solid state laser medium 2b, to the total reflection coating 3b, is reflected by the total reflection coating 3b, and is amplified again when passing through a path extending from the total reflection coating, via the solid state laser medium 2b, to the antireflection coating 1b. The laser light 6 then emerges from the second solid-state-laser pumping module unit.

The S-polarized component of the laser light 6 which is incident upon the first solid-state-laser pumping module unit 12a is incident upon the second solid-state-laser pumping module unit 12b as P-polarized light after the polarization of the laser light is rotated by the polarization rotator 13 by 90 degrees. On the other hand, the P-polarized component of the laser light 6 which is incident upon the first solid-state-laser pumping module unit 12a is incident upon the second solid-state-laser pumping module unit 12b as S-polarized light after the polarization of the laser light is rotated by the polarization rotator 13 by 90 degrees.

Thus, in accordance with the above-mentioned structure, since the phase difference which is provided to the polarized components of the laser light in the above-mentioned directions of the two axes of the thermal birefringence is compensated, the incident laser light 6 is outputted with its polarization state being held.

That is, since the solid-state-laser pumping module shown in FIG. 4 can amplify the incident laser light 6 in an arbitrary polarization state without changing the polarization state of the laser light, the solid-state-laser pumping module can constitute a laser amplifier that amplifies the laser light 6 which is placed in an arbitrary polarization state and which is not linearly polarized light.

A total reflection mirror for reflecting the laser light 6 and a partial reflection mirror for reflecting a part of the laser light 6, and for allowing a remaining part of the laser light to pass therethrough, which are not shown, are prepared, and either the total reflection mirror or the partial reflection mirror is disposed on the optical axis of the laser light 6 which has not yet been incident upon the first solid-state-laser pumping module unit 12a and either the partial reflection mirror or the total reflection mirror is disposed on the optical axis of the laser light 6 which has passed through the first solid state laser pumping module unit 12b and emerges from the first solid-state-laser pumping module unit.

A laser cavity in which the laser light 6 laser-oscillates within a path which consists of the above-mentioned total reflection mirror, the first and second solid-state-laser pumping module units 12a and 12b, and the above-mentioned partial reflection mirror can be thus constructed.

As a result, the above-mentioned laser cavity can be used as a laser device which outputs the laser light 6 amplified thereby, via the above-mentioned partial reflection mirror, toward outside the laser cavity. Since the phase difference which is provided to the polarized components of the laser light in the above-mentioned directions of the two axes, which are caused by the thermal birefringence, is compensated, a high-beam-quality laser output in an arbitrary polarization state can be obtained.

The example shown in FIG. 4 compensates the phase change in the laser light using the combination of the two solid-state-laser pumping module units 12a and 12b and the polarization rotator 13. As an alternative, in accordance with this embodiment, either a laser amplifier or a laser oscillator can be constructed of two or more combinations of the two solid-state-laser pumping modules and the polarization rotator. The laser amplifier or laser oscillator which is constructed in this way can provide higher power and a higher gain.

Although the example shown uses a transmission optical element, such as a quartz rotator or a ½ wavelength plate, as the polarization rotator 13, the polarization rotator is not limited to such a transmission optical element. It is apparent that as an alternative, a prism for rotating the polarization of incident light by reflecting it or for spatially rotating an image of incident light by 90 degrees so that the direction of the polarization of the laser light 6 which is incident upon the first solid-state-laser pumping module unit 12a is perpendicular to the second solid-state-laser pumping module unit 12b can be disposed, and this variant offers the same advantages.

Instead of using the polarization rotator 13, the first and second solid-state-laser pumping module units 12a and 12b can be arranged so that the direction of the polarization of the laser light 6 incident upon the first solid-state-laser pumping module unit 12a at an incidence angle θ is perpendicular to that of the polarization of the laser light 6 incident upon the second solid-state-laser pumping module unit 12b at the incidence angle θ.

That is, the second solid-state-laser pumping module unit 12b is arranged with respect to the first solid-state-laser pumping module unit 12a so that a direction perpendicular to a plane including the optical axis of the laser light 6 and the normal 7 to the light incidence surface of the first solid-state-laser pumping module unit 12a is included in a plane including the optical axis of the laser light 6 and the normal 7 to the light incidence surface of the second solid-state-laser pumping module unit 12b.

Specifically, the second solid-state-laser pumping module unit 12b is arranged with respect to the first solid-state-laser pumping module unit 12a so that the longitudinal direction of the first solid-state-laser pumping module unit 12a is perpendicular to that of the second solid-state-laser pumping module unit 12b. An optical system, such as a reflecting mirror, is arranged on a path between those pumping module units 12a and 12b, through which the laser light 6 propagates, and the direction of the polarization of the laser light 6 is adjusted so that the polarization of the laser light 6 incident upon the second solid-state-laser pumping module unit 12b at an incidence angle θ is perpendicular to the polarization of the laser light 6 incident upon the first solid-state-laser pumping module unit 12a at the incidence angle θ.

When the optical system is constructed in this way, laser light which is, as S-polarized light, incident upon the first solid-state-laser pumping module unit 12a is, as P-polarized light, incident upon the second solid-state-laser pumping module unit 12b, whereas laser light which is, as P-polarized light, incident upon the first solid-state-laser pumping module unit 12a is, as S-polarized light, incident upon the second solid-state-laser pumping module unit 12b. Therefore, this variant offers the same advantages as provided the above-mentioned example in which the polarization rotator 13 is disposed.

Embodiment 3.

In the solid-state-laser pumping module, as shown in FIG. 1, in accordance with above-mentioned embodiment 1, the power stored in the laser medium can be increased or the density of heat generated in the laser medium can be decreased with increase in the incidence angle θ. In addition, the length over which the laser light propagates through the inside of the laser medium 2 can be increased with increase in the incidence angle θ.

However, even when the incidence angle is set to θ=90 degrees which is the maximum, the length over which the laser light propagates through the inside of the laser medium 2 increases by a factor of as little as about 1.38 when the refractive index of the solid state laser medium 2 is 1.45, and increases by a factor of as little as about 1.20 when the refractive index of the solid state laser medium 2 is 1.82, as compared with a case where the incidence angle θ is 0 degrees.

That is, in the above-mentioned pumping module, the rate of increase in the gain with increase in the incidence angle is small compared with the rate of increase in the stored power with increase in the incidence angle. In addition, a margin of the incidence angle which is provided to the antireflection coating 1 decreases with increase in the incidence angle θ. In accordance with this embodiment 3, a structure for improving the above-mentioned shortcomings of the solid-state-laser pumping module of above-mentioned embodiment 1 is provided.

FIG. 5A is a diagram showing the structure of a solid-state-laser pumping module in accordance with embodiment 3 of the present invention, and FIG. 5B is a side view of the solid-state-laser pumping module in FIG. 5A when viewed from the direction of the x-axis. A total reflection mirror 14 reflects incident laser light 6 amplified by a solid state laser medium 2 so as to apply the laser light 6 to the solid state laser medium 2 again.

The same components as shown in FIG. 1 are designated by the same reference numerals, and the repeated explanation of the components will be omitted hereafter. In FIGS. 5A and 5B, an antireflection coating 1 and other components in the solid-state-laser pumping module are omitted in order to make a relationship between the solid state laser medium 2 and the laser light 6 be clear.

The laser light 6 is incident upon the solid state laser medium 2 while being linearly polarized in a direction (i.e., the direction of the x-axis) perpendicular to a plane including the optical axis of the laser light and the normal 7 to a light incidence surface of the solid state laser medium (i.e., while being in an S-polarization state), or in a direction existing in the plane including the optical axis of the laser light and the normal 7 and being perpendicular to the optical axis (i.e., while being in a P-polarization state). FIG. 5A shows a case where the polarization of the laser light 6 is S-polarization.

Next, the operation of the solid-state-laser pumping module in accordance with this embodiment of the present invention will be explained.

Pumping light 8 which is incident upon a side surface of the solid state laser medium 2 propagates through the inside of the solid state laser medium 2 while being reflected by inner surfaces of the solid state laser medium 2. As a result, the solid state laser medium 2 absorbs the pumping light 8 to generate a gain.

The laser light 6 which is the target whose power is to be amplified is incident upon the solid state laser medium 2 at an incidence angle θ, and is amplified by the solid state laser medium 2 until it reaches the total reflection coating 3 after passing through the antireflection coating 1. The laser light 6 which is amplified by the solid state laser medium 2 until it reaches the total reflection coating 3 is reflected by the total reflection coating 3, and is further amplified when passing through the inside of the solid state laser medium 2 again.

Then, the laser light 6 passes through the antireflection coating 1 and emerges from the solid-state-laser pumping module. The laser light 6 which has been amplified by the solid state laser medium 2 is total-reflected by the total reflection mirror 14, and is incident upon the solid state laser medium 2 again.

After the above-mentioned amplification processing is repeated a number of times, the laser light 6 is outputted to outside the pumping module as output light. FIG. 5 shows an example in which the laser light 6 emerges from the pumping module after being subjected to the amplification processing three times within the solid state laser medium 2 by the total reflection mirror 14.

At this time, since the laser light 6 is incident upon the laser medium 2 as S-polarized light or P-polarized light, it is not influenced by the thermal birefringence which occurs in the laser medium 2, but is amplified with its polarization state being held.

Assuming that the direction perpendicular to the plane including the optical axis of the laser light 6 and the normal 7 is that of the x axis, the direction of the normal 7 is that of the z-axis, and the direction of the normal to an xz plane is that of the y-axis, and the number of times that the laser light 6 is reflected within the solid state laser medium 2 is m, the solid state laser medium 2 has a size of a in the direction of the x-axis and a size of b in the direction of the y-axis which form a relationship given by the following equation (3) when only a region through which the laser light 6 passes is taken into consideration, where m is a positive integer.
bₐ=m·a/cos θ (3)

Thus, the solid-state-laser pumping module in accordance with this embodiment has a length in the direction of the y-axis which is substantially m times that of the solid-state-laser pumping module shown in FIG. 1. For this reason, the solid-state-laser pumping module in accordance with this embodiment can store power which is m times that stored in the solid-state-laser pumping module shown in FIG. 1 with the beam diameter of the laser light 6 being held constant.

Since the laser light 6 passes through the inside of the solid state laser medium 2 m times, the length over which the laser light 6 passes through the inside of the laser medium 2 is m times what it is in the case of the solid-state-laser pumping module shown in FIG. 1, and therefore the solid-state-laser pumping module in accordance with this embodiment can provide a large gain.

Since the solid-state-laser pumping module in accordance with this embodiment can acquire high stored power and a large gain with the incidence angle θ and the beam diameter of the laser light 6 being held constant, the solid-state-laser pumping module can provide high-power laser light with a high degree of efficiency.

In addition, as shown in FIG. 5A, also in accordance with this embodiment, the pumping light 8 is incident upon the solid state laser medium 2 via each of side surfaces of the solid state laser medium 2 which are parallel to an xy plane.

Since the solid-state-laser pumping module is thus constructed, the length of absorption of the pumping light 8 can be adjusted according to the size a of the solid state laser medium in the direction of the x-axis, and all the power stored in the solid state laser medium 2 can be adjusted according to the size bₐ of the solid state laser medium in the direction of the y-axis. As a result, the absorbed amount of the pumping light 8 by the solid state laser medium and required power stored in the solid state laser medium can be designed independently. Since side surfaces having a wider width are selected, as the pumping light incidence surfaces, from among the side surfaces which constitute the disk of the solid state laser medium 2, the pumping light 8 can be easily incident upon the solid state laser medium 2.

FIG. 5 shows the example in which the pumping light 8 is incident upon the solid state laser medium 2 via the side surfaces of the solid state laser medium 2 which are parallel to an xy plane. As an alternative, the pumping light 8 can be incident upon the solid state laser medium 2 via other side surfaces of the solid state laser medium 2 which are parallel to an xz plane. When the pumping module is constructed in this way, since a longer length of absorption of the pumping light 8 is obtained, a high degree of absorption efficiency is acquired even if the solid state laser medium 2 is made of a material of small absorption of the pumping light 8.

Furthermore, since the length of absorption of the pumping light of the solid state laser medium 2 can be varied with the ratio of the size a of the solid state laser medium 2 in the direction of the x-axis and the beam diameter of the laser light 6 being fixed, the absorbed amount of the pumping light 8 by the solid state laser medium 2 and the beam diameter of the laser light 6 can be designed independently.

In above-mentioned embodiment 3, the example in which the solid state laser medium 2 satisfies above-mentioned equation (3) in size is shown. It is apparent from the above description that almost the same advantages are acquired when the solid state laser medium 2 satisfies the following relationship: bₐ>a in size. Especially, a case where the incident laser light 6 is not circular in cross section, but is elliptical or rectangular in cross section can be considered.

In this case, the ratio of the size of the region irradiated by the laser light 6 on the laser light incidence surface of the solid state laser medium 2 and the size of the laser light incidence surface of the solid state laser medium 2 is set so that it has the same value for both the direction of the x-axis and the direction of the y-axis.

When the solid state laser medium is constructed in this way, the size of the region irradiated by the laser light 6 and the size of the laser light incidence surface of the solid state laser medium become nearly equal, the power stored in the solid state laser medium 2 can be taken out with a high degree of efficiency.

Embodiment 4.

In accordance with above-mentioned embodiment 3, the polarization state of the incident laser light 6 needs to be restricted to either S-polarization or P-polarization with respect to the solid state laser medium 2. In contrast, a solid-state-laser pumping module in accordance with this embodiment 4 is so constructed as to amplify laser light 6 in an arbitrary polarization state by using a total reflection mirror 4 like that of above-mentioned embodiment 3.

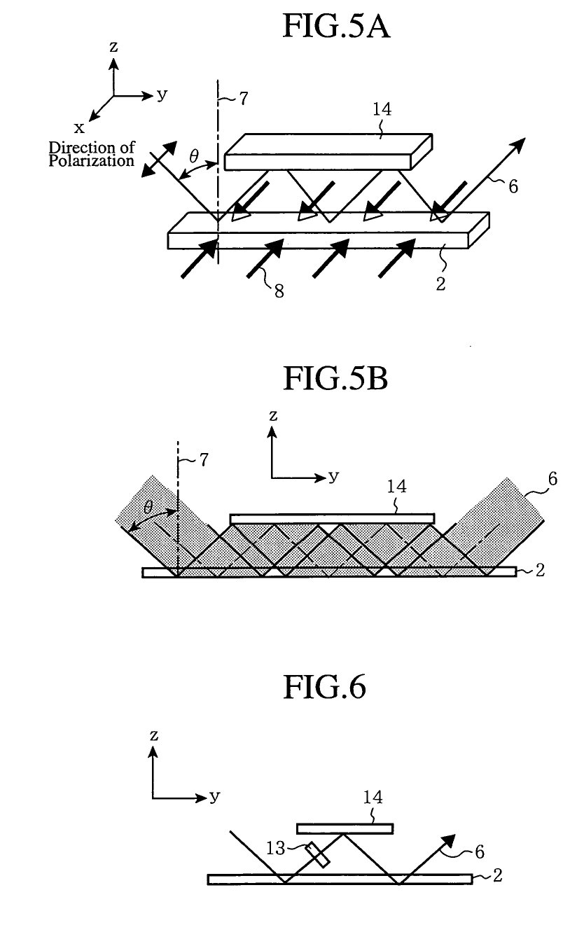

FIG. 6 is a diagram showing the structure of the solid-state-laser pumping module in accordance with embodiment 4 of the present invention. In accordance with this embodiment, a polarization rotator 13 is arranged on a path of the laser light 6 reflected by a solid state laser medium 2 disposed in the solid-state-laser pumping module in accordance with above-mentioned embodiment 3.

The same components as shown in FIGS. 1 and 4 are designated by the same numerals, and the repeated explanation of the components will be omitted hereafter. In FIG. 6, an antireflection coating 1 and other components in the solid-state-laser pumping module are omitted in order to make a relationship between the solid state laser medium 2 and the laser light 6 be clear.

Next, the operation of the solid-state-laser pumping module in accordance with this embodiment of the present invention will be explained.

Laser light 6 which is incident upon the solid state laser medium 2 is amplified by the solid state laser medium 2 and then emerges to outside the pumping module. After the polarization of the laser light 6 emerging from the solid-state-laser pumping module is rotated by the polarization rotator 13 by 90 degrees, the laser light 6 is reflected by a total reflection mirror 14, and is then incident upon and amplified by the solid state laser medium 2 again.

The S-polarized component of the laser light 6 which is incident upon the solid state laser medium 2 is further incident upon the solid state laser medium 2 as P-polarized light after the polarization of the laser light is rotated by the polarization rotator 13 by 90 degrees and the laser light is reflected by the total reflection mirror 14.

On the other hand, the P-polarized component of the laser light 6 which is incident upon the solid state laser medium 2 is further incident upon the solid state laser medium 2 as S-polarized light after the polarization of the laser light is rotated by the polarization rotator 13 by 90 degrees and the laser light is reflected by the total reflection mirror 14.

Thus, in accordance with the above-mentioned structure, since the phase difference which is provided to the polarized components of the laser light in the directions of the above-mentioned two axes of thermal birefringence which occur in the solid state laser medium is compensated, the incident laser light 6 is outputted with its polarization state being held.

That is, since the solid-state-laser pumping module shown in FIG. 6 can amplify the laser light 6 in an arbitrary polarization state without changing the polarization state of the laser light, the solid-state-laser pumping module can constitute a laser amplifier that amplifies the laser light 6 which is placed in an arbitrary polarization state and which is not linearly polarized light.

A total reflection mirror for reflecting the laser light 6 and a partial reflection mirror for reflecting a part of the laser light 6, and for allowing a remaining part of the laser light to pass therethrough, which are not shown, are prepared, and either the total reflection mirror or the partial reflection mirror is disposed on the optical axis of the laser light 6 which has not yet been incident upon the solid state laser medium 2 and either the partial reflection mirror or the total reflection mirror is disposed on the optical axis of the laser light 6 which has emerged from the above-mentioned solid-state-laser pumping module.

A laser cavity in which the laser light 6 laser-oscillates within a path which consists of the above-mentioned total reflection mirror, the solid-state-laser pumping module in accordance with the present invention, and the above-mentioned partial reflection mirror can be thus constructed.

As a result, the above-mentioned laser cavity can be used as a laser device which outputs the laser light 6 amplified thereby, via the partial reflection mirror, toward outside the laser cavity. Since the phase difference which is provided to the polarized components of the laser light in the directions of the above-mentioned two axes, which are caused by the thermal birefringence, is compensated, a high-beam-quality laser output in an arbitrary polarization state can be obtained.

FIG. 6 shows the example in which the laser light is reflected by the solid state laser medium 2 two times.

Change in the polarization state of the laser light is compensated since the laser light is reflected by the polarization rotator 13 and the solid state laser medium 2 twice. Therefore, the number of times that the laser light is reflected by the laser medium 2 can be alternatively set to 2k (k is a natural number), and a number of polarization rotators 13 can be arranged so that the polarization of the laser light is rotated every time when the laser light is reflected by the laser medium for an odd-numbered time.

That is, the laser light 6 is reflected by the total reflection coating 3 for the first time after amplified by the solid state laser medium 2 for the first time. After the polarization of the laser light 6 is then rotated by the first polarization rotator 13, which is arranged on the optical axis extending to the total reflection mirror 14, by 90 degrees, the laser light 6 is reflected toward the solid state laser medium 2 by the total reflection mirror 14.

The laser light 6 reflected by the total reflection mirror 14 is incident upon and amplified by the solid state laser medium 2 again, is then reflected by the total reflection coating 3 for the second time, and is further reflected toward the solid state laser medium 2 by the total reflection mirror 14.

The laser light 6 reflected by the total reflection mirror 14 is further amplified by the solid state laser medium 2, and is then reflected by the total reflection coating 3 for the third time. After the polarization of the laser light 6 is then rotated by the second polarization rotator 13, which is arranged on the optical axis extending to the total reflection mirror 14, by 90 degrees, the laser light 6 is reflected toward the solid state laser medium 2 by the total reflection mirror 14.

The laser light 6 reflected by the total reflection mirror 14 is further amplified by the solid state laser medium 2, is then reflected by the total reflection coating 3 for the fourth time, and is further reflected toward the solid state laser medium 2 by the total reflection mirror 14.

In other words, such a process is performed repeatedly in such a manner that the polarization of the laser light 6 which is amplified by the solid state laser medium 2 is rotated by k polarization rotators 13 arranged on the optical path of the reflected laser light 6 by 90 degrees every time the laser light is reflected by the total reflection coating 3 for the (2k−1)-th time.

After the laser light 6 amplified by the solid state laser medium 2 is reflected by the total reflection coating 3 for the 2k-th time, the laser light is reflected by the total reflection mirror 14 and is then incident upon the solid state laser medium 2 again without passing through any polarization rotator 13.

Thus, in accordance with the above-mentioned structure, since the phase difference which is provided to the polarized components of the laser light in the directions of the above-mentioned two axes of the thermal birefringence is compensated, the incident laser light 6 is outputted with its polarization state being held.

That is, since the solid-state-laser pumping module shown in FIG. 6 can amplify the laser light 6 in an arbitrary polarization state without changing the polarization state of the laser light, the solid-state-laser pumping module can constitute a laser amplifier that amplifies the laser light 6 which is placed in an arbitrary polarization state and which is not linearly polarized light.

Although the example in which the polarization rotator 13 is used in order to rotate the polarization of the laser light 6 by 90 degrees is shown is FIG. 6, the total reflection mirror 14 can be so constructed as to have a function of rotating the polarization of the laser light 6 by 90 degrees, instead of using the polarization rotator 13. For example, in a case where a quartz rotator for rotating the polarization of incident light by 45 degrees is formed on a laser light incidence surface of the total reflection mirror 14, the laser light 6 passes through the quartz rotator twice when reflected by the total reflection mirror 14.

As a result, the polarization of the laser light 6 is rotated by 90 degrees. As an alternative, in order to rotate the polarization of the laser light 6, a prism can be used as the total reflection mirror 14 so that either a polarization rotation effect by total reflection in the prism or an effect of rotating a spatial distribution can be applied to the laser light incident upon the prism.

Embodiment 5.

In the solid-state-laser pumping module in accordance with above-mentioned embodiment 3, although the laser light 6 propagates through the inside of the solid state laser medium 2 a number of times while being repeatedly reflected between the total reflection coating 3 and the total reflection mirror 14, there are some regions through which the laser light 6 does not pass in the solid state laser medium 2.

When there are some regions through which the laser light 6 does not pass in the solid state laser medium 2 which is entirely pumped by the pumping light 8, the power stored in the solid state laser medium by the pumping cannot be fully taken out by the laser light 6. For this reason, some stored power remains in the solid state laser medium and the efficiency of the laser device is reduced.

In addition, although some reflected beams of the laser light 6 can be bundled into one beam and can be made to pass through the solid state laser medium 2 so that no region through which the laser light 6 does not pass occurs, the total beam width of the laser light 6 is increased inevitably. For this reason, when the laser light 6 is incident upon the solid state laser medium 2 and when the laser light 6 emerges from the solid state laser medium 2 toward outside the pumping module, the laser light 6 is partially blocked by the total reflection mirror 14 and therefore the efficiency of the laser device is reduced.

This embodiment 5 is made to solve the above-mentioned problem.

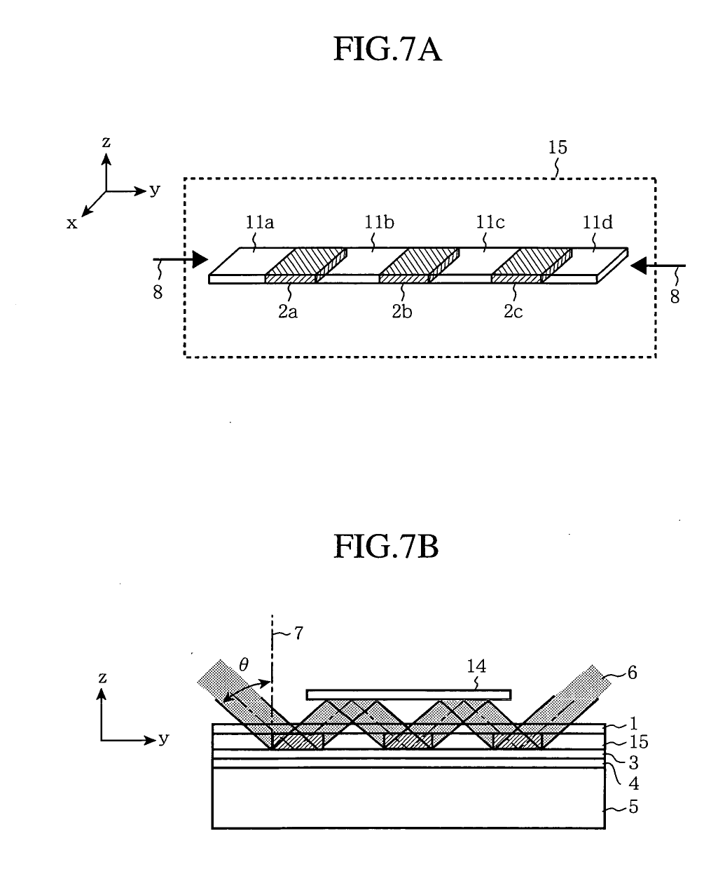

FIG. 7A is a diagram showing the structure of a thin disk-shaped solid state laser medium in accordance with embodiment 5 of the present invention. Each of solid state laser media 2a to 2c and slab waveguides 11a to 11d is shaped like a thin disk. A pumping medium member 15 includes the plurality of solid state laser media 2a to 2c which are connected to one another via the slab waveguides 11a to 11d, and is shaped like a plate which extends lengthwise in a longitudinal direction. Each of the plurality of solid state laser media 2a to 2c has the same functions as the solid state laser medium 2 shown in FIG. 1.

The plurality of solid state laser media 2a to 2c, and the plurality of slab waveguides 11a to 11d are bonded to one another with an optical contact or diffusion bonding, as explained in above-mentioned embodiment 1. Furthermore, as explained in above-mentioned embodiment 1, the plurality of solid state laser media 2a to 2c and the plurality of slab waveguides 11a to 11d can be formed into a ceramic in which they are integrally formed as the pumping medium member 15.

FIG. 7B is a cross-sectional view in an xz plane showing the structure of a solid-state-laser pumping module in accordance with embodiment 5 of the present invention, which uses the pumping medium member 15 shown in FIG. 7A. An antireflection coating 1 having the same functions as that previously explained with reference to FIG. 1 is disposed so as to cover the whole of an upper surface of the pumping medium member 15.

A total reflection coating 3 is disposed so as to cover the whole of a lower surface of the pumping medium member 15, and is fixed to a heat sink 5 via a bonding agent 4. The functions of the total reflection coating 3, bonding agent 4, and heat sink 5 are the same as those previously explained with reference to FIG. 1.

Laser light 6 is incident upon the pumping medium member 15 while being linearly polarized in a direction (i.e., the direction of the x-axis) perpendicular to a plane including the optical axis of the laser light and a normal 7 to a light incidence surface of the pumping medium member 15 (i.e., while being in an S-polarization state), or in a direction existing in the plane including the optical axis of the laser light and the normal 7 and being perpendicular to the optical axis (i.e., in a P-polarization state).

Next, the operation of the solid-state-laser pumping module in accordance with this embodiment of the present invention will be explained.

Pumping light 8 which is made to be incident upon the slab waveguide 11a from a side surface of the pumping medium member 15 which is parallel to an xz plane propagates through the slab waveguide 11a while being repeatedly reflected by inner surfaces of the slab waveguide 11a, and is then incident upon the solid state laser medium 2a.

The pumping light 8 which is incident upon the solid state laser medium 2a is absorbed by the solid state laser medium 2a and causes it to generate a gain. At this time, remaining pumping light which is not absorbed by the solid state laser medium 2a passes through the solid state laser medium 2a and is then incident upon the slab waveguide 11b, and propagates through the slab waveguide 11b while being repeatedly reflected by inner surfaces of the slab waveguide 11b and is incident upon the solid state laser medium 2b. As a result, the remaining pumping light from the solid state laser medium 2a is absorbed by the solid state laser medium 2b and causes it to generate a gain.

Furthermore, remaining pumping light which is not absorbed by the solid state laser medium 2b passes through the solid state laser medium 2b and is then incident upon the slab waveguide 11c, and propagates through the slab waveguide 11c while being repeatedly reflected by inner surfaces of the slab waveguide 11c and is incident upon the solid state laser medium 2c. Then, the remaining pumping light from the solid state laser medium 2b is similarly absorbed by the solid state laser medium 2c and causes it to generate a gain.

Finally, remaining pumping light which is not absorbed by even the solid state laser medium 2c passes through the solid state laser medium 2c, and is then incident upon the slab waveguide 11d, and propagates through the slab waveguide 11d while being repeatedly reflected by inner surfaces of the slab waveguide lid and then emerges from the pumping medium member 15.

Pumping light 8 which is incident upon the slab waveguide 11dfrom another side surface of the pumping medium member 15, which is parallel to an xz plane, is subjected to a process similar to the above-mentioned process and causes each of the plurality of solid state laser media 2a to 2c to generate a gain.

That is, the pumping light 8 which is incident upon the slab waveguide 11d is absorbed by the solid state laser medium 2c and causes it to generate a gain, remaining pumping light which is not absorbed by the solid state laser medium 2c causes the solid state laser medium 2b to generate a gain, and remaining pumping light which is not absorbed by the solid state laser medium 2b causes the solid state laser medium 2a to generate a gain.

Laser light 6 which is incident upon the pumping medium member 15 at an incidence angle θ passes through the antireflection coating 1 and is then incident upon and amplified by the solid state laser medium 2a. This laser light 6 is amplified again by the solid state laser medium 2a after reflected by the total reflection coating 3, and then passes through and emerges from the antireflection coating 1.

The laser light 6 is incident upon the pumping medium member 15 at the incidence angle θ again after total-reflected by the total reflection mirror 14, and then passes through the antireflection coating 1 and is incident upon and amplified by the solid state laser medium 2b. The amplified laser light 6 is amplified again by the solid state laser medium 2b after reflected by the total reflection coating 3, and then passes through and emerges from the antireflection coating 1.

The laser light 6 is further total-reflected by the total reflection mirror 14 and is incident upon the pumping medium member 15 at the incidence angle θ, and further passes through the antireflection coating 1 and is incident upon and amplified by the solid state laser medium 2c. The amplified laser light 6 is amplified again by the solid state laser medium 2c after reflected by the total reflection coating 3, and then passes through and emerges from the antireflection coating 1.

Since the laser light 6 is sequentially incident upon the plurality of solid state laser media 2a to 2c as S-polarized light or P-polarized light, the laser light is amplified by the plurality of solid state laser media without being influenced by thermal birefringence which occurs in each of the plurality of solid state laser media 2a to 2c, and with its polarization state being held.

Thus, the arrangement of the plurality of solid state laser media 2a to 2c only in the plurality of regions through which the laser light 6 passes respectively can reduce stored power which remains in the pumping medium member 15 without being taken out by the laser light 6, thereby improving the efficiency of the solid-state-laser pumping module.

Since the pumping light 8 is absorbed by the plurality of solid state laser media 2a to 2c, the efficiency of absorption of the pumping light 8 can be improved and this results in an improvement in the efficiency of the solid-state-laser pumping module.

In addition, since the laser light 6 is reflected and amplified by these solid state laser media 2a to 2c a number of times, large stored power and a large gain can be provided. The present embodiment thus makes it possible to provide a laser device which can obtain high-power laser light 6 with a high degree of efficiency.

Furthermore, in accordance with this embodiment, only two light sources each for generating pumping light 8, such as semiconductor lasers (LDs), have only to be disposed on a side of the slab waveguide 11a and on a side of the slab waveguide 11d. For this reason, the solid-state-laser pumping module can be reduced in size as compared with a case where two or more solid-state-laser pumping modules each employing one solid state laser medium 2 as shown in FIG. 1 are arranged.

In addition, since stored power generated by the pumping light 8 is distributed among the plurality of solid state laser media 2a to 2c, the amount of heat generated in each of the plurality of solid state laser media can be reduced. As a result, the temperature rise of each of the plurality of solid state laser media can be suppressed and the efficiency of the laser device can be improved.

When the amount of heat generated in each of the plurality of solid state laser media thus decreases, a bonding agent, such as an organic bonding agent having a low maximum working temperature, can be used as the bonding agent 4.

Some organic bonding agents as mentioned above can bond bonding surfaces of components which are to be bonded to one another to one another while getting into gaps between the bonding surfaces to cover minute projections and depressions which exist in the bonding surfaces.

When such a bonding agent is used as the bonding agent 4, the antireflection coating 1, solid state laser medium 2, and total reflection coating 3 can be easily fixed to the heat sink 5 even if the heat sink 5 has a low degree of flatness.

When a bonding agent which is softer than the solid state laser medium 2, i.e., which has a higher degree of softness than the solid state laser medium 2 is used as the bonding agent 4, it can also be expected that the bonding agent 4 serves as a shock absorbing material that lessens stress to the solid state laser medium 2.

Like above-mentioned embodiment 1, when the amount of heat generated in each of the plurality of solid state laser media is reduced, an optical bonding agent having a refractive index which causes the pumping light 8 to satisfy the total reflection condition when passing through each of the plurality of solid state laser media 2a to 2c and having a property of little absorption of the pumping light 8 can be used as the bonding agent 4.

That is, since the pumping light 8 can be confined in the pumping medium member 15 because of the total reflection by the inner surfaces of the pumping medium member 15, losses of the pumping light 8 can be reduced and the efficiency of the pumping module can be improved.

When the above-mentioned optical bonding agent is used as the bonding agent 4, since the total reflection coating 3 does not need to have a function of total-reflecting the pumping light 8, it becomes easy to design the total reflection coating and the thickness of the total reflection coating can be thinned.

As shown in FIG. 7B, the antireflection coating 1, total reflection coating 3, bonding agent 4, and heat sink 5 are integrally formed onto the pumping medium member 15. As an alternative, an antireflection coating 1, a total reflection coating 3, a bonding agent 4, and a heat sink 5 can be disposed for each of the plurality of solid state laser media 2a to 2c. In the example of FIG. 7, the total reflection mirror 14 is constructed of a single mirror. As an alternative, a plurality of total reflection mirrors 14 can be arranged at a plurality of locations upon which the laser light 6 reflected by the pumping medium member can be sequentially incident.

Although the pumping medium member 15 shown in FIGS. 7A and 7B includes the three solid state laser media 2a to 2c, it is apparent that the pumping medium member 15 has only to include two or more solid state laser media and this case provides the same advantages.

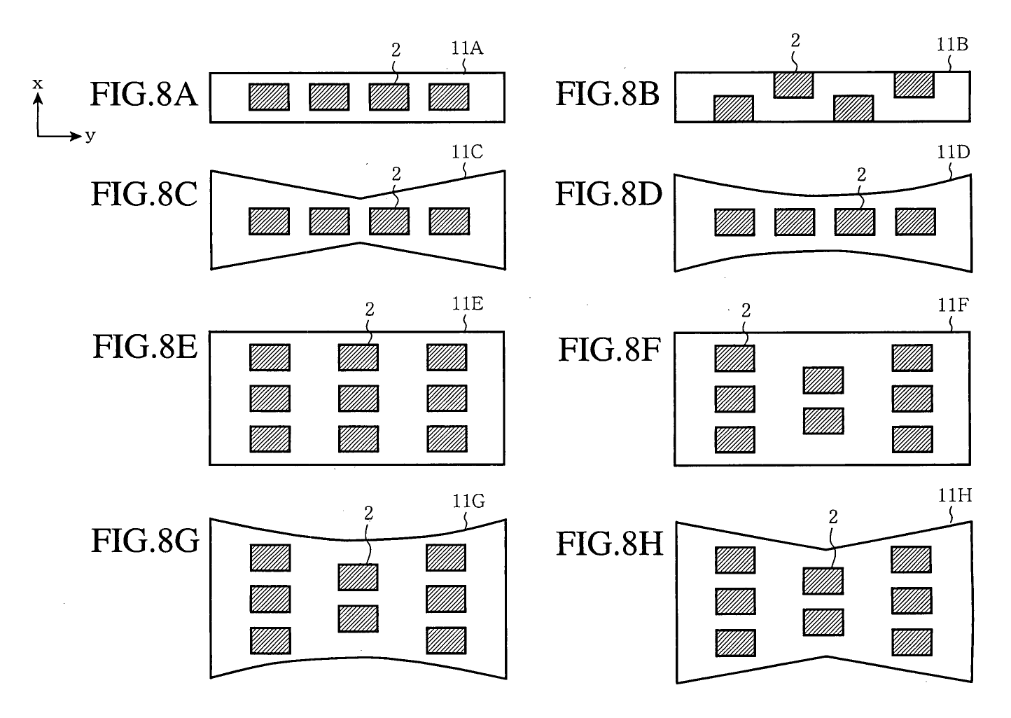

The pumping medium member 15 can alternatively have any one of structures as shown in FIGS. 8A to 8H.

The pumping medium member 15 shown in FIG. 8A is so constructed that the whole perimeter of each solid state laser medium 2 including side surfaces of each solid state laser medium 2 perpendicular to the direction of the x-axis is covered by a slab waveguide 11A, unlike that shown in FIG. 7. This structure makes it possible for the pumping light 8 to be incident upon each solid state laser medium of the pumping medium member 15 not only from the side surfaces perpendicular to the direction of the y-axis, but also from the side surfaces perpendicular to the direction of the x-axis.

As a result, the pumping medium member 15 can have a uniform pumping distribution. The pumping light 8 which is incident upon the slab waveguide 11A propagates through the slab waveguide 11A while being repeatedly reflected by inner surfaces of the slab waveguide 11A, and is then incident upon each solid state laser medium 2, as mentioned above.

The pumping medium member 15 shown in FIG. 8B is so constructed that only one side surface of each solid state laser medium 2 which is perpendicular to the direction of the x-axis is not covered by a slab waveguide 11B. In accordance with this structure, pumping light 8 is applied to the pumping medium member from both side surfaces which are perpendicular to the direction of the x-axis so that the pumping light 8 can be directly incident upon each solid state laser medium 2 without passing through the slab waveguide 11B.

For this reason, the pumping medium member 15 can make the power stored in each of the plurality of solid state laser media 2 more uniform, as compared with the structure, such as a structure as shown in FIG. 7, which makes remaining pumping light which is not absorbed by a certain solid state laser medium 2 be absorbed by another solid state laser media 2.

FIGS. 8C and 8D show other examples of the pumping medium member 15 in which a plurality of solid state laser media 2 are aligned in the direction of the y-axis, and a slab waveguide 11C or 11D is disposed so as to cover all side surfaces of each of the plurality of solid state laser media which are perpendicular to the direction of the x-axis or y-axis. The slab waveguide 11C of the pumping medium member 15 shown in FIG. 8C is so formed that two side surfaces thereof which are perpendicular to the direction of the x-axis are tapered such that the width of each of the two side surfaces is linearly reduced with distance from each of both ends thereof toward a center thereof. The slab waveguide 11C of the pumping medium member 15 shown in FIG. 8D is so formed that two side surfaces thereof which are perpendicular to the direction of the x-axis are tapered such that the width of each of the two side surfaces is reduced in a smooth curve with distance from each of both ends thereof toward a center thereof.

The intensity of pumping light 8 incident upon each of both side surfaces of the pumping medium member 15 which are perpendicular to the direction of the y-axis is reduced to that of remaining pumping light as the pumping light is absorbed by solid state laser media 2 in the pumping medium member 15. At this time, the remaining pumping light is condensed by the slab waveguide 11C or 11D which is formed into the tapered shape as it propagates toward the direction of the center of the pumping medium member 15.

That is, in each of the slab waveguides 11C and 11D which is formed into the tapered shape, since the cross-sectional area is gradually reduced with distance from each of the incidence end surfaces via which the pumping light 8 is incident upon the slab waveguide toward the center of the pumping medium member 15, the pumping light 8 is condensed to the center of the pumping medium member 15.

Thus, in accordance with any of the structures shown in FIG. 8C and FIG. 8D, since the remaining pumping light is made to propagate through the pumping medium member and be absorbed by solid state laser media 2 while being condensed to the center of the pumping medium member, the power stored in each of the plurality of solid state laser media 2 can be made uniform.

FIGS. 8E and 8F show examples of the pumping medium member in which a plurality of solid state laser media 2 are arranged not only in the direction of the y-axis but also in the direction of the x-axis. In accordance with these structures, since the number of solid state laser media 2 can be increased, the total power stored in the plurality of solid state laser media 2 can be further increased.

Since two or more solid state laser media 2 are also arranged in the direction of the x-axis, both side surfaces of the pumping medium member 15 which are perpendicular to the direction of the y-axis and which serves as light incidence surfaces via which the pumping light 8 is incident upon the pumping medium member 15 can be enlarged and therefore the pumping light can be easily introduced into the pumping medium member.

In the structure shown in FIG. 8F, the number of solid state laser media 2 which are arranged in the direction of the x-axis and in the central portion of the pumping medium member 15 is less than the number of solid state laser media 2 which are arranged along each of both side surfaces of the slab waveguide 11E or 11F which are perpendicular to the direction of the x-axis.

When pumping light 8 is incident upon the slab waveguide via each of both side surfaces of the slab waveguide which are perpendicular to the direction of the y-axis, the pumping light 8 is absorbed by the two or more solid state laser media 2 arranged along each of both the side surfaces of the slab waveguide which are perpendicular to the direction of the y-axis, and remaining pumping light which is not absorbed by these solid state laser media 2 is absorbed by the two or more solid state laser medium 2 arranged in the central portion of the pumping medium member.

Then, when the same number of solid state laser media 2 as those arranged along each of both the side surfaces of the slab waveguide which are perpendicular to the direction of the y-axis are arranged in the central portion of the pumping medium member 15, as shown in FIG. 8E, the remaining pumping light is shared among the same number of solid state laser media 2. As a result, the power stored in the two or more solid state laser media 2 which are arranged in the central portion of the pumping medium member becomes lower than that stored in the two or more solid state laser media 2 which are arranged along each of both the side surfaces of the slab waveguide which are perpendicular to the direction of the y-axis.

In contrast, in the example as shown in FIG. 8F, since the number of solid state laser media 2 which are arranged in the central portion of the pumping medium member is reduced compared with the number of solid state laser media which are arranged along each of both the side surfaces of the slab waveguide which are perpendicular to the direction of the y-axis, the number of objects among which the remaining pumping light is shared decreases. As a result, the power stored in each of the plurality of solid state laser media 2 arranged in the pumping medium member 15 can be made uniform.

FIGS. 8G and 8H show examples of the pumping medium member in which two or more solid state laser media 2 are also arranged in the direction of the x-axis, like FIGS. 8E and 8F. Each of slab waveguides 11G and 11H which covers all side surfaces of each of a plurality of solid state laser media 2 is formed into a tapered shape, like those shown in FIGS. 8C and 8D. In accordance with these structures, the power stored in each of the plurality of solid state laser media 2 arranged in the pumping medium member can be made uniform, as in the case of those shown in FIGS. 8C and 8D. Furthermore, the power stored in each of the plurality of solid state laser media 2 arranged in the pumping medium member can be increased, as in the case of those shown in FIGS. 8E and 8F.

In the examples shown in FIGS. 8A to 8H, each of the plurality of solid state laser media 2 has a light incidence surface which is shaped like a rectangle. As an alternative, each of the plurality of solid state laser media 2 can have a light incidence surface which is shaped like a circle or ellipse.

When each of the plurality of solid state laser media 2 is constructed in this way, since the efficiency of taking out laser light 6 which is circular in a cross section perpendicular to the optical axis thereof can be improved, the laser light can be provided with a high degree of efficiency.

As in the case of the structure shown in FIG. 6, the solid-state-laser pumping module can be so constructed that 2k (k is a natural number) solid state laser media 2 is aligned in each line running in the direction of the y-axis direction of the pumping medium member 15, and a number of polarization rotators 13 each for rotating the polarization of laser light 6 reflected by an odd-numbered solid state laser medium 2 by 90 degrees are arranged among the plurality of solid state laser media.

When the solid-state-laser pumping module is constructed in this way, the phase difference which is provided to the polarized components of the laser light 6 in the directions of the above-mentioned two axes of thermal birefringence which occurs in each solid state laser medium is compensated. Even if the laser light 6 in an arbitrary polarization state is incident upon the solid-state-laser pumping module, the laser light 6 is made to emerge from the solid-state-laser pumping module with it polarization state being held. Therefore, the solid-state-laser pumping module can amplify the laser light 6 in an arbitrary polarization state.

In addition, a laser oscillator which consists of this solid-state-laser pumping module can provide a high-beam-quality laser output using the laser light 6 in an arbitrary polarization state.

Embodiment 6.

The solid-state-laser pumping module in accordance with above-mentioned embodiment 5 is so constructed as to take out the power stored in the plurality of solid state laser media by means of one beam of laser light, as previously explained. In contrast, a solid-state-laser pumping module in accordance with embodiment 6 is so constructed as to take out the power stored in a plurality of solid state laser media by means of plural beams of laser light.

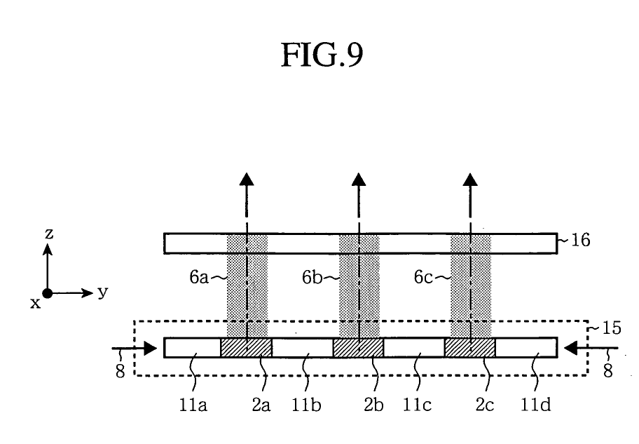

FIG. 9 is a diagram showing the structure of a laser device which uses the solid-state-laser pumping module in accordance with embodiment 6 of the present invention. A partial reflection mirror 16 reflects a part of each of the plural beams of laser light 6a to 6c, and allows a remaining part of each of the plural beams of laser light 6a to 6c to pass therethrough. The same components as shown in FIGS. 1 and 7 are designated by the same numerals, and the repeated explanation of the components will be omitted hereafter. In FIG. 9, an antireflection coating 1 and other components which are disposed in a lower portion of a pumping medium member 15 of the solid-state-laser pumping module are omitted in order to make a relationship between the plurality of solid state laser media 2a to 2c and the plural beams of laser light 6a to 6c be clear.

Next, the operation of the solid-state-laser pumping module in accordance with this embodiment of the present invention will be explained.

Pumping light 8 which is made to be incident upon the slab waveguide 11a from a side surface of the pumping medium member 15 which is parallel to an xz plane propagates through the slab waveguide 11a while being repeatedly reflected by inner surfaces of the slab waveguide 11a, and is then incident upon the solid state laser medium 2a.

The pumping light 8 which is incident upon the solid state laser medium 2a is absorbed by the solid state laser medium 2a and causes it to generate a gain. At this time, remaining pumping light which is not absorbed by the solid state laser medium 2a passes through the solid state laser medium 2a and is then incident upon the slab waveguide 11b, and propagates through the slab waveguide 11b while being repeatedly reflected by inner surfaces of the slab waveguide 11b and is incident upon the solid state laser medium 2b. As a result, the remaining pumping light from the solid state laser medium 2a is absorbed by the solid state laser medium 2b and causes it to generate a gain.

Furthermore, remaining pumping light which is not absorbed by even the solid state laser medium 2b passes through the solid state laser medium 2b and is then incident upon the slab waveguide 11c, and propagates through the slab waveguide 11c while being repeatedly reflected by inner surfaces of the slab waveguide 11c and is incident upon the solid state laser medium 2c. Then, the remaining pumping light from the solid state laser medium 2b is similarly absorbed by the solid state laser medium 2c and causes it to generate a gain.

Finally, remaining pumping light which is not absorbed by the solid state laser medium 2c passes through the solid state laser medium 2c, and is then incident upon the slab waveguide 11d, and propagates through the slab waveguide 11d while being repeatedly reflected by inner surfaces of the slab waveguide 11d and then emerges from the pumping medium member 15. Pumping light 8 which is incident upon the slab waveguide 11d from another side surface of the pumping medium member 15, which is parallel to an xz plane, is subjected to a process similar to the above-mentioned process and causes each of the plurality of solid state laser media 2a to 2c to generate a gain.

That is, the pumping light 8 which is incident upon the slab waveguide 11d is absorbed by the solid state laser medium 2c and causes it to generate a gain, remaining pumping light which is not absorbed by the solid state laser medium 2c causes the solid state laser medium 2b to generate a gain, and remaining pumping light which is not absorbed by the solid state laser medium 2b causes the solid state laser medium 2a to generate a gain.

When the plurality of solid state laser media 2a to 2c are pumped and generate their respective gains, as mentioned above, the plural beams of laser light 6a to 6c are made to be incident upon the pumping medium member 15 via the partial reflection mirror 16. The plural beams of laser light 6a to 6c which are incident upon the pumping medium member 15 pass through the antireflection coating 1, and are incident upon and amplified by the plurality of solid state laser media 2a to 2c, respectively. The amplified plural beams of laser light 6a to 6c are amplified again by the plurality of solid state laser media 2a to 2c, respectively, after reflected by the total reflection coating 3, and then penetrate through the antireflection coating 1 and emerge from the pumping medium member.

When the plural beams of laser light 6a to 6c which are amplified by and emerges from the pumping medium member 15 reach the partial reflection mirror 16, they partially pass through the partial reflection mirror 16, and are partially reflected by the partial reflection mirror 16 and are incident upon the pumping medium member 15 again. This process is repeated and then laser oscillations occur between the pumping medium member 15 and the partial reflection mirror 16 because of the plural beams of laser light 6a to 6c. As a result, the plural beams of laser light 6a to 6c whose power is fully amplified emerge from the partial reflection mirror 16 toward outside the solid-state-laser pumping module. In other words, the solid-state-laser pumping module operates as a laser cavity which outputs the plural beams of laser light 6a to 6c.

Since the solid-state-laser pumping module which is constructed in this way can output the power stored in the plurality of solid state laser media 2a to 2c to outside the solid-state-laser pumping module, as the plural beams of laser light 6a to 6c, the solid-state-laser pumping module can obtain a high-power laser output.

Furthermore, in accordance with this embodiment, only two light sources each for generating pumping light 8, such as semiconductor lasers (LDs), have only to be disposed on a side of the slab waveguide 11a and on a side of the slab waveguide 11d. For this reason, the solid-state-laser pumping module can be reduced in size as compared with a case where two or more solid-state-laser pumping modules each employing one solid state laser medium 2 as shown in FIG. 1 are arranged.

Since stored power generated by the pumping light 8 is distributed among the plurality of solid state laser media 2a to 2c, the amount of heat generated in each of the plurality of solid state laser media can be reduced. As a result, the temperature rise of each of the plurality of solid state laser media can be suppressed and the efficiency of the laser device can be improved.

When the amount of heat generated in each of the plurality of solid state laser media thus decreases, a bonding agent, such as an organic bonding agent having a low maximum working temperature, can be used as the bonding agent 4.

Some organic bonding agents as mentioned above can bond bonding surfaces of components which are to be bonded to one another to one another while covering minute projections and depressions which exist in the bonding surfaces.

When such a bonding agent is used as the bonding agent 4, the antireflection coating 1, plurality of solid state laser media 2, and total reflection coating 3 can be easily fixed to the heat sink 5 even if the heat sink 5 has a low degree of flatness.

When a bonding agent which is softer than the plurality of solid state laser media 2, i.e., which has a higher degree of softness than the plurality of solid state laser media 2 is used as the bonding agent 4, it can also be expected that the bonding agent 4 serves as a shock absorbing material that lessens stress to the plurality of solid state laser media 2.

Like above-mentioned embodiment 1, when the amount of heat generated in each of the plurality of solid state laser media is reduced, an optical bonding agent having a refractive index which causes the pumping light 8 to satisfy the total reflection condition when passing through each of the plurality of solid state laser media 2a to 2c and having a property of little absorption of the pumping light 8 can be used as the bonding agent 4.

That is, since the pumping light 8 can be confined between the bonding agent 4 and the antireflection coating 1 in the pumping medium member 15 because of the total reflection by the bonding agent 4 which is the optical bonding agent, losses of the pumping light 8 can be reduced and the efficiency of the pumping module can be improved.

When the above-mentioned optical bonding agent is used as the bonding agent 4, since the total reflection coating 3 does not need to have a function of total-reflecting the pumping light 8, it becomes easy to design the total reflection coating and the thickness of the total reflection coating can be thinned.

In the example of FIG. 9, the antireflection coating 1, total reflection coating 3, bonding agent 4, and heat sink 5 can be integrally formed onto the pumping medium member 15. As an alternative, an antireflection coating 1, a total reflection coating 3, a bonding agent 4, and a heat sink 5 can be disposed for each of the plurality of solid state laser media 2a to 2c.

In the example of FIG. 9, the partial reflection mirror 16 is constructed of a single mirror. As an alternative, a plurality of partial reflection mirrors 16 can be arranged with respect to the plural beams of laser light 6a to 6c, respectively.

Although the pumping medium member 15 shown in FIG. 9 includes the three solid state laser media 2a to 2c, it is apparent that the pumping medium member 15 has only to include two or more solid state laser media and this case provides the same advantages.

In order to adjust the beam mode of each of the plural beams of laser light 6a to 6c which are generated by the laser cavity, a plurality of partial reflection mirrors 16 each having a concave surface can be used for the plural beams of laser light 6a to 6c, respectively. The solid-state-laser pumping module which is constructed in this way can constitute a laser oscillator having a desired beam mode.

Instead of the partial reflection mirror 16, a plurality of lenses are arranged on the optical paths of the plural beams of laser light 6a to 6c, respectively, so that the plural beams of laser light 6a to 6c can be guided, via the plurality of lenses, to the plurality of solid state laser media of the pumping medium member 15 using a plane mirror, respectively. The solid-state-laser pumping module which is constructed in this way can condense the plural beams of laser light 6a to 6c using the plurality of lenses to make each of the plural beams of laser light 6a to 6c to have a beam diameter which satisfies the stability condition of the laser cavity.

As a result, a stable laser oscillator can be provided. In addition, when the partial reflection mirror 16 can be replaced by a single plane mirror, the laser oscillator can be manufactured at a low cost.

The plurality of lenses which are arranged on the optical paths of the plural beams of laser light 6a to 6c, respectively, can be a lens array which is formed on one substrate in the form of an array. When the plurality of lenses is constructed of a lens array, the structure of the laser device can be simplified since it is not necessary to individually fix each of the plurality of lenses into place. In this case, a stable laser oscillator can be provided.

The plural beams of laser light 6a to 6c generated by the plurality of laser cavities can be made to be in phase with one another. The synchronization of the phases of the plural beams of laser light can be established by using an injection seeding method of preparing, for example, two or more laser cavities as mentioned, and making common seed light be incident upon the two or more laser cavities, and making laser oscillations which are synchronized with the phase of the seed light occur in the two or more laser cavities, respectively, a method of arranging two or more laser cavities as mentioned so that a part of laser-oscillated light generated by each of the two or more laser cavities is mixed into other laser cavities and they generate plural beams of laser light in phase with one another, or the like.

Since the laser oscillator which is constructed in this way can make the plural beams of laser light outputted thereby be in phase with one another, the plural beams of laser light can be handled as a single output beam of laser light, and a high-power high-beam-quality laser output can be provided.

### INDUSTRIAL APPLICABILITY

As mentioned above, since the solid-state-laser pumping module and laser oscillator in accordance with the present invention can suppress the temperature rise at the time of pumping a thin disc laser medium thereof, and can provide a high gain, they can be applied to laser devices for laser radars and laser devices for machining which require a high-power laser beam.

1. A solid-state-laser pumping module comprising:
a pumping medium member including a plate-shaped solid state laser medium that provides a gain generated by absorption of pumping light to laser light to amplify the laser light, a reflecting member disposed on a surface of said solid state laser medium which is opposite to a laser light incidence surface of said solid state laser medium, for reflecting the laser light which is incident upon said solid state laser medium via said light incidence surface and which propagates through said solid state laser medium, and a cooling member for removing heat which is transferred thereto, via said reflecting member, from said solid state laser medium,
the laser light incidence surface of said solid state laser medium having a size of a in a direction perpendicular to a plane defined by both an optical axis of said laser light and a normal to the laser light incidence surface of said solid state laser medium, and a size of b in a longitudinal direction perpendicular to said direction and said normal, the sizes having a relationship given by b=a/cos θ, where θ is an incidence angle at which said laser light is incident upon the laser light incidence surface.

2. The solid-state-laser pumping module according to claim 1, characterized in that the laser light is linearly polarized light which is polarized in either the direction perpendicular to the plane defined by both the optical axis of said laser light and the normal to the laser light incidence surface of said solid state laser medium, or a direction in said plane.

3. The solid-state-laser pumping module according to claim 1, characterized in that the incidence angle θ of the laser light is 45 degrees or more.

4. The solid-state-laser pumping module according to claim 1, characterized in that the incidence angle θ of the laser light is a Brewster angle peculiar to the solid state laser medium.

5. The solid-state-laser pumping module according to claim 1, characterized in comprising a slab waveguide member having an incidence end surface via which the pumping light generated by a pumping light source is incident thereupon, and an emergence end surface having a smaller area than the incidence end surface, said emergence end surface being bonded to a pumping light incidence surface of the solid state laser medium, for introducing the pumping light from said pumping light source into said solid state laser medium via said pumping light incidence surface.

6. The solid-state-laser pumping module according to claim 1, characterized in that the reflecting member and the cooling member are bonded to each other using a bonding agent having a higher degree of softness than the solid state laser medium, for bonding the reflecting member and the cooling member to each other while covering projections and depressions which exist on their bonding surfaces which are to be bonded to each other.

7. The solid-state-laser pumping module according to claim 1, characterized in that the reflecting member and the cooling member are bonded to each other using an optical bonding agent having a smaller refractive index than the solid state laser medium.

8. The solid-state-laser pumping module according to claim 1, characterized in that the laser light incidence surface of the solid state laser medium of the pumping medium member has at least m regions (m is a positive integer) which are running along said longitudinal direction, each of said m regions having a size of a in the direction perpendicular to a plane defined by both the optical axis of said laser light and the normal to the laser light incidence surface of said solid state laser medium, and a size of b in the longitudinal direction perpendicular to said direction and said normal, the sizes having a relationship given by b=a/cos θ, where θ is the incidence angle at which said laser light is incident upon the laser light incidence surface, and characterized in that said pumping module comprises a reflecting mirror for successively reflecting the laser light reflected by the reflecting member toward said solid state laser medium so that the laser light is incident upon said solid state laser medium m times at the incidence angle θ.

9. The solid-state-laser pumping module according to claim 8, characterized in comprising a polarization rotating member disposed in a laser light path between the reflecting member and the reflecting mirror, for rotating polarization of the laser light by 90 degrees.

10. The solid-state-laser pumping module according to claim 8, characterized in that the reflecting mirror rotates the polarization of the laser light reflected from the reflecting member by 90 degrees.

11. The solid-state-laser pumping module according to claim 8, characterized in that the pumping medium member includes solid state laser media arranged at locations thereof upon which the laser light which is successively reflected by the reflecting mirror is successively incident, and a slab waveguide member for connecting said solid state laser media to one another, and for making the pumping light pass through said solid state laser media.

12. The solid-state-laser pumping module according to claim 11, characterized in that said slab waveguide member covers all surfaces of each of the solid state laser media except the laser light incidence surface of each of the solid state laser media and a bonding surface of each of the solid state laser media which is bonded to the reflecting member, and said slab waveguide member has a cross-sectional area which decreases with distance from the incidence end surface of said slab waveguide member via which the pumping light is incident upon said slab waveguide member such that the introduced pumping light is condensed to one of the solid state laser media which is arranged at a position distant from said incidence end surface.

13. A solid-state-laser pumping module comprising:
a plurality of pumping medium members each including a plate-shaped solid state laser medium that provides a gain generated by absorption of pumping light to laser light to amplify the laser light, a reflecting member disposed on a surface of said solid state laser medium which is opposite to a laser light incidence surface of said solid state laser medium, for reflecting the laser light which is incident upon said solid state laser medium via said light incidence surface and which propagates through said solid state laser medium, and a cooling member for removing heat which is transferred thereto, via said reflecting member, from said solid state laser medium, the laser light incidence surface of said solid state laser medium having a size of a in a direction perpendicular to a plane defined by both an optical axis of said laser light and a normal to the laser light incidence surface of said solid state laser medium, and a size of b in a longitudinal direction perpendicular to said direction and said normal, the sizes having a relationship given by b=a/cos θ, where θ is an incidence angle at which said laser light is incident upon the laser light incidence surface, and said plurality of pumping medium members being arranged so that each of said plurality of pumping medium members outputs the laser light which is amplified by said solid state laser medium thereof and is reflected by said reflecting member thereof as output light, and so that the output light from one of said plurality of pumping medium members arranged at a preceding stage is incident upon another one of said plurality of pumping medium members arranged at a next stage and said laser light is successively amplified by said plurality of pumping medium members.

14. The solid-state-laser pumping module according to claim 13, characterized in comprising a polarization rotating member disposed in a laser light path between the one of said plurality of pumping medium members arranged at the preceding stage and the other one of said plurality of pumping medium members arranged at the next stage, for rotating polarization of the laser light by 90 degrees.

15. The solid-state-laser pumping module according to claim 13, characterized that the other one of said plurality of pumping medium members arranged at the next stage is arranged so that a direction perpendicular to a plane defined by both an optical axis of the laser light incident upon the one of said plurality of pumping medium members arranged at the preceding stage, and a normal to the laser light incidence surface of the solid state laser medium of the one of said plurality of pumping medium members matches with a direction perpendicular to a plane defined by both an optical axis of the laser light incident upon the other one of said plurality of pumping medium members, and a normal to the laser light incidence surface of the solid state laser medium of the other one of said plurality of pumping medium members.

16. A laser oscillator comprising:
a pumping medium member including a plurality of plate-shaped solid state laser media which provide their respective gains generated by absorption of pumping light to plural beams of laser light to amplify the plural beams of laser light, a reflecting member disposed on surfaces of said plurality of said solid state laser media which are opposite to laser light incidence surfaces of said plurality of solid state laser media, for reflecting the plural beams of laser light which are incident upon said plurality of solid state laser media via said light incidence surfaces and which propagate through said plurality of solid state laser media, respectively, and a cooling member for removing heat which is transferred thereto, via said reflecting member, from said plurality of solid state laser media, said plurality of solid state laser media being arranged at locations of said pumping medium member upon which the plural beams of laser light are incident, respectively, and said plurality of solid state laser media being connected to one another via a slab waveguide member which makes the pumping light propagate through said plurality of solid state laser media; and
an optical system for repeatedly making the plural beams of laser light be incident upon said plurality of solid state laser media of said pumping medium member, respectively, and making the plural beams of laser light reflected from said reflecting member be re-incident upon said plurality of solid state laser media of said pumping medium member, respectively, so as to cause laser oscillations.

17. The laser oscillator according to claim 16, characterized in that the plural beams of laser light which oscillate in said plurality of solid state laser media respectively are made to be in phase with one another.

18. The laser oscillator according to claim 16, characterized in that said slab waveguide member covers all surfaces of each of the plurality of solid state laser media except the laser light incidence surface of each of the plurality of solid state laser media and a bonding surface of each of the plurality of solid state laser media which is bonded to the reflecting member, and said slab waveguide member has a cross-sectional area which decreases with distance from an incidence end surface of said slab waveguide member via which the pumping light is incident upon said slab waveguide member such that the introduced pumping light is condensed to one of the plurality of solid state laser media which is arranged at a position distant from said incidence end surface.

19. The laser oscillator according to claim 16, characterized in that the reflecting member and the cooling member are bonded to each other using a bonding agent having a higher degree of softness than the plurality of solid state laser media, for bonding the reflecting member and the cooling member to each other while covering projections and depressions which exist on their bonding surfaces which are to be bonded to each other.

20. The laser oscillator according to claim 16, characterized in that the reflecting member and the cooling member are bonded to each other using an optical bonding agent having a smaller refractive index than the plurality of solid state laser media.
